(19) United States
(12) Patent Application Publication
(10) Pub. No.: US 2024/0085609 A1
(43) Pub. Date: Mar. 14, 2024

(54) HOLOGRAM RECORDING MEDIUM, HOLOGRAM OPTICAL ELEMENT, OPTICAL DEVICE, OPTICAL COMPONENT, AND METHOD FOR FORMING HOLOGRAM DIFFRACTION GRATING

(71) Applicant: SONY GROUP CORPORATION, TOKYO (JP)

(72) Inventors: HISAYA HARA, TOKYO (JP); TAKAHIRO OHE, TOKYO (JP); KENSHIRO KAWASAKI, TOKYO (JP)

(21) Appl. No.: 18/260,441

(22) PCT Filed: Sep. 29, 2021
(86) PCT No.: PCT/JP2021/035921

§ 371 Date: Jul. 5, 2023

(30) Foreign Application Priority Data
Jan. 13, 2021 (JP) 2021-003830

(51) Int. Cl. G02B 5/32; G02B 5/18; G03H 1/02; G11B 7/0065; G11B 7/24044

(52) U.S. Cl. CPC G02B 5/32; G02B 5/18; G03H 1/02; G11B 7/0065; G11B 7/24044

(57) ABSTRACT

Provided is a hologram recording medium that has high in-plane uniformity of a diffraction peak wavelength and can be peeled off from a release layer after exposure. The hologram recording medium includes a protective layer and a photosensitive layer. The initial maximum load on the protective layer measured in a tensile test is 3 N or more and 1000 N or less. The photosensitive layer contains a polymerizable compound and a polymerization initiator, and the polymerization initiator contains an electron-donating initiator and an electron-accepting initiator.

### TECHNICAL FIELD

The present disclosure relates to a hologram recording medium, a hologram optical element, an optical device including the hologram optical element, an optical component, and a method for forming a hologram diffraction grating.

### BACKGROUND ART

In a hologram recording medium, a light and dark (interference) pattern of light is recorded as a pattern of, for example, the refractive index on a photosensitive layer. Hologram recording media are widely used in fields of optical information processing, security, medicine, head-up displays, and the like. A hologram recording medium enables recording of three-dimensional information of an object as a large capacity of optical information, and therefore has attracted attention as a next-generation recording medium.

A known hologram recording medium includes a photosensitive layer and a protective layer. For a hologram recording medium having such a configuration, adjustment of physical properties of a protective layer has been proposed. For example, Patent Document 1 discloses a layer arrangement including a substrate layer and a photopolymer layer, in which the substrate layer has an elastic strain of 0.2% or less in response to a tensile force of at least 80 N in a substrate width of 1 m.

### CITATION LIST

### Patent Document

Patent Document 1: Japanese Patent Application Laid-Open No. 2017-523475

### SUMMARY OF THE INVENTION

### Problems to be Solved by the Invention

A hologram recording medium is desired to have high in-plane uniformity of a diffraction peak wavelength, and desired to be peelable from a release layer such as a glass substrate or the like after exposure. However, conventional hologram recording media hardly obtain these characteristics.

An object of the present disclosure is to provide a hologram recording medium that has high in-plane uniformity of a diffraction peak wavelength and can be peeled off from a release layer after exposure, a hologram optical element, an optical device including the hologram optical element, an optical component, and a method for forming a hologram diffraction grating.

### Solutions To Problems

In order to solve the above-described problems, a first disclosure is

a hologram recording medium including

a protective layer and a photosensitive layer,

the photosensitive layer containing a polymerizable compound and a polymerization initiator,

the polymerization initiator containing an electron-donating initiator and an electron-accepting initiator, in which

an initial maximum load on the protective layer measured in a tensile test is 3 N or more and 1000 N or less.

A second disclosure is

a hologram optical element including

a protective layer and a hologram layer,

the hologram layer containing a polymer and a polymerization initiator having a structure changed by irradiation with external energy, the irradiation that generates an active species,

the polymerization initiator containing an electron-donating initiator and an electron-accepting initiator, in which

an initial maximum load on the protective layer measured in a tensile test is 3 N or more and 1000 N or less.

A third disclosure is an optical device including the hologram optical element of the second disclosure.

A fourth disclosure is an optical component including the hologram optical element of the second disclosure.

A fifth disclosure is

a method for forming a hologram diffraction grating, the method including

selectively reacting a hologram recording medium including a protective layer and a photosensitive layer, by using an electromagnetic ray having an amplitude modulated spatially,

the photosensitive layer containing a polymerizable compound and a polymerization initiator,

the polymerization initiator containing an electron-donating initiator and an electron-accepting initiator, in which

an initial maximum load on the protective layer measured in a tensile test is 3 N or more and 1000 N or less.

### BRIEF DESCRIPTION OF DRAWINGS

FIG. 1 is a cross-sectional view illustrating an example of a configuration of a hologram recording medium according to a first embodiment of the present disclosure.

FIG. 2 is a cross-sectional view illustrating an example of a configuration of a hologram recording medium according to a modification.

FIG. 3 is a cross-sectional view illustrating an example of a configuration of a hologram optical element according to a second embodiment of the present disclosure.

FIG. 4 is a schematic diagram illustrating an example of a configuration of an optical system for hologram recording.

FIG. 5 is a schematic view of an optical system for hologram recording at the time of two-beam exposure.

### MODE FOR CARRYING OUT THE INVENTION

The embodiments of the present disclosure will be described in the following order.

1 Overview of Present Disclosure

2 First Embodiment (Example of Hologram Recording Medium)

3 Second Embodiment (Example of Hologram Optical Element)

4 Third Embodiment (Examples of Optical Device and Optical Unit)

5 Fourth Embodiment (Example of Method for Forming Hologram Diffraction Grating)

6 Analysis Method

In the present description, the term “and/or” means “at least one”, and for example, in a case where the term is used in a phrase “X and/or Y”, this phrase means three cases of “only X”, “only Y”, and “X and Y”.

### 1 Overview of Present Disclosure

The present inventors have studied a hologram recording medium that can be peeled off from a release layer such as a glass substrate or the like after exposure. As a result, the present inventors have found that if a hologram recording medium includes a protective layer on which an initial maximum load measured in a tensile test is 3 N or more, the hologram recording medium can be peeled off from a release layer after exposure.

Moreover, the present inventors have studied a hologram recording medium including a protective layer on which an initial maximum load is in the above-described numerical range, and as a result, have found that this hologram recording medium has a problem that diffraction wavelength unevenness occurs after exposure and thus the in-plane uniformity of a diffraction peak wavelength deteriorates. The cause of this characteristic deterioration is considered to be as follows. That is, if the initial maximum load on the protective layer is 3 N or more, the protective layer has high rigidity and is difficult to deform. Therefore, the protective layer hardly follow cure shrinkage of the photosensitive layer at the time of exposure, and thus deformation unevenness of the hologram recording medium occurs in the in-plane direction of the hologram recording medium, and the above-described diffraction wavelength unevenness occurs.

Therefore, the present inventors have conducted studies to solve the above-described problems. As a result, the present inventors have found that the above-described problems can be solved if the photosensitive layer contains, as a polymerization initiator, an electron-donating initiator and an electron-accepting initiator.

That is, the present disclosure can provide a hologram recording medium that has high in-plane uniformity of a diffraction peak wavelength and can be peeled off from a release layer after exposure as a result of combination of a protective layer on which an initial maximum load measured in a tensile test is 3 N or more and a photosensitive layer containing an electron-donating initiator and an electron-accepting initiator as a polymerization initiator, a hologram optical element, an optical device including the hologram optical element, an optical component, and a method for forming a hologram diffraction grating.

### 2 First Embodiment

### Configuration of Hologram Recording Medium

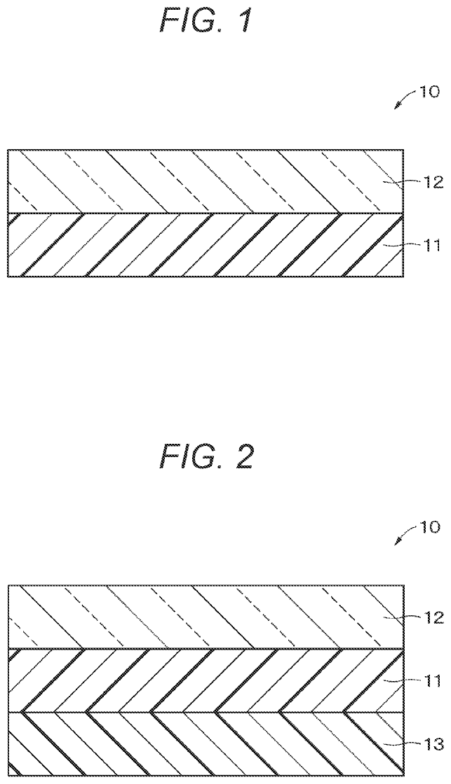

FIG. 1 is a cross-sectional view illustrating an example of a configuration of a hologram recording medium 10 according to a first embodiment of the present disclosure. The hologram recording medium 10 includes a photosensitive layer 11 and a protective layer 12. As illustrated in FIG. 2, the hologram recording medium 10 may be bonded to a release layer 13 as necessary.

### Protective Layer

The protective layer 12 is provided on one surface (first surface) of the photosensitive layer 11. The protective layer 12 protects the photosensitive layer 11. The protective layer 12 may have a function as a support that supports the photosensitive layer 11. The protective layer 12 has transparency to visible light or the like. The protective layer 12 is preferably a film from the viewpoint of improving the peelability of the hologram recording medium 10 from the release layer 13. In the present description, the film also includes a sheet. The protective layer 12 may be a single-layer film or a multilayer film.

The lower limit of the initial maximum load on the protective layer 12 measured in a tensile test is 3 N or more, preferably 3.5 N or more, and more preferably 4 N or more. If the lower limit of the initial maximum load on the protective layer 12 is 3 N or more, the hologram recording medium 10 can be peeled off from the release layer 13. The upper limit of the initial maximum load on the protective layer 12 measured in a tensile test is 1000 N or less, preferably 500 N or less, and more preferably 100 N or less. If the upper limit of the initial maximum load on the protective layer 12 is more than 1000 N, the protective layer 12 has excessively high rigidity and there is a possibility that the hologram recording medium 10 is difficult to peel off from the release layer 13.

The initial maximum load on the protective layer 12 measured in a tensile test is measured as follows. First, the protective layer 12 is collected from the hologram recording medium 10. Examples of the method of collecting the protective layer 12 from the hologram recording medium 10 include, but are not limited to, the following methods, and any method may be used as long as the photosensitive layer 11 can be removed while damage to the protective layer 12 is suppressed. The protective layer 12 is peeled off from the photosensitive layer 11. Subsequently, the photosensitive composition remaining on the surface of the protective layer 12 is rubbed off using cotton, paper, or the like moistened with an organic solvent that does not affect the protective layer 12 or with water, and thus the protective layer 12 is obtained from which the photosensitive layer 11 has been removed. Alternatively, the protective layer 12 may be obtained from which the photosensitive layer 11 has been removed by scraping off the photosensitive composition remaining on the surface of the protective layer 12 using a jig such as a cutter or the like, or by peeling off the photosensitive composition remaining on the surface of the protective layer 12 using an adhesive tape. As the organic solvent that does not affect the protective layer 12, for example, an organic solvent is used such as acetone, methyl ethyl ketone, methanol, ethanol, tetrahydrofuran, toluene, methylene chloride, chloroform, or the like.

Subsequently, the protective layer 12 from which the photosensitive layer 11 has been removed is cut into a rectangular shape having a width of 20 mm and a length of 150 mm to produce a test piece. Next, a stress-strain curve of the test piece is obtained by a tensile test in accordance with JIS K 7127 (1999), and the initial maximum load is determined from the stress-strain curve.

Details of the measurement conditions are as follows.

Measuring device: Instron universal tester model 5566

Tensile speed: 5 mm/min

Distance between chucks: 130 mm (typical value)

Measurement environment: temperature 23° C., humidity 50% RH (typical values)

Tensile direction: longitudinal direction (length direction) of test piece

The protective layer 12 preferably contains at least one selected from the group consisting of cycloolefin-based resins, polycarbonate-based resins, and polyester-based resins. As a result, even in a case where the protective layer 12 has a small thickness, the lower limit of the initial maximum load on the protective layer 12 measured in a tensile test can be easily set to 3 N or more. In a case where the protective layer 12 contains two or more resins, the two or more resins may be mixed, copolymerized, or stacked to form a laminated film.

Examples of the cycloolefin-based resins include norbornene-based polymers, vinyl alicyclic hydrocarbon polymers, cyclic conjugated diene polymers, and the like. Among them, norbornene-based polymers are preferable. Examples of the norbornene-based polymers include ring-opened polymers of norbornene-based monomers, norbornene-based copolymers obtained by copolymerizing a norbornene-based monomer and an a-olefin such as ethylene or the like, and the like. Examples of the polycarbonate-based resins include aliphatic polycarbonate-based resins, aromatic polycarbonate-based resins, and the like. Examples of the polyester-based resins include polyethylene terephthalate-based resins.

The thickness of the protective layer 12 may be appropriately set by those skilled in the art, but is preferably 0.1 μm or more and 200 μm or less, and more preferably 1 μm or more and 120 μm or less from the viewpoint of transparency and rigidity of the hologram recording medium 10.

The protective layer 12 may include a hard coat layer as necessary. The hard coat layer may be provided on both surfaces or on one surface of the protective layer 12. In a case where the protective layer 12 includes a hard coat layer, the initial maximum load on the protective layer 12 is measured in a state where the hard coat layer is included. The hard coat layer contains, for example, an ultraviolet curable resin. The hard coat layer may contain an additive such as fine particles or the like as necessary.

### Photosensitive Layer

The photosensitive layer 11 contains a photosensitive composition. The photosensitive composition contains a polymerizable compound and a polymerization initiator. The photosensitive composition may further contain a binder resin.

The thickness of the photosensitive layer 11 may be appropriately set by those skilled in the art, but is preferably 0.1 μm or more and 100 μm or less, and more preferably 1 μm or more and 30 μm or less from the viewpoint of diffraction efficiency and sensitivity to light.

Hereinafter, each component in the photosensitive composition will be described in detail.

### Polymerizable Compound

The polymerizable compound preferably contains a compound represented by the general formula (1) described below. If the polymerizable compound contains the compound represented by the general formula (1) described below, a high refractive index modulation degree (Δn) can be obtained without a heating step after exposure. The compound represented by the general formula (1) described below has good transparency and good solubility in an organic solvent.

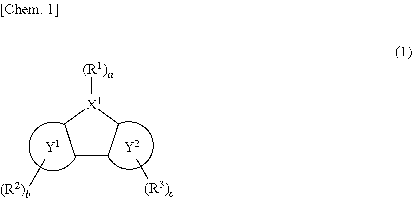

In the general formula (1), X¹ represents an oxygen atom, a nitrogen atom, a phosphorus atom, a carbon atom, or a silicon atom. In a case where X¹ represents an oxygen atom, a is 0, in a case where X¹ represents a nitrogen atom or a phosphorus atom, a is 1, and in a case where X¹ represents a carbon atom or a silicon atom, a is 2.

Y¹ and Y² each represent a benzene ring or a naphthalene ring. Y¹ and Y² may simultaneously represent a benzene ring, or a case may be excluded in which Y¹ and Y² simultaneously represent a benzene ring. In order to obtain a high refractive index modulation degree (Δn) without a heating step after exposure, at least one of Y¹ or Y² preferably represents a naphthalene ring, and both Y¹ and Y² more preferably represent a naphthalene ring. In a case where Y¹ and/or Y2 represents a benzene ring, b or c corresponding to Y¹ and/or Y² representing the benzene ring is 4. In a case where Y¹ and/or Y² represents a naphthalene ring, b and/or c corresponding to Y¹ and/or Y² representing the naphthalene ring is 6.

R¹ to R³ each represent hydrogen or a substituent represented by *-Z¹ (R⁴)_{d} (in which * represents a binding site). In a case where a plurality of R¹s, a plurality of R²s, and a plurality of R³s are present, the plurality of R¹s, the plurality of R²s, and the plurality of R³s may be of an identical kind or of different kinds, and all of the plurality of R¹s, the plurality of R²s, and the plurality of R³s in the general formula (1) are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may contain an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of an identical kind or of different kinds, and all of the plurality of R⁴s in the general formula (1) is not simultaneously hydrogen.

In the general formula (1), X¹ represents an oxygen atom, a nitrogen atom, a phosphorus atom, a carbon atom, or a silicon atom. Furthermore, it is considered that an effect of the present disclosure can also be expected for Group 14 elements, Group 15 elements, and Group 16 elements (however, transition metals are excluded) other than the above-described atoms.

Among the above-described atoms, an oxygen atom, a nitrogen atom, and a carbon atom, which are representative elements in an organic compound, are preferable from the viewpoint of ease of synthesis of a compound, and the atomic refraction of each atom is as follows. Oxygen atom: 1.6 to 2.2, nitrogen atom: 3.5 to 4.4, carbon atom: 1.7 to 2.4 (Optical Review, Vol. 44, No. 8, 2015, p. 298-303). In the present embodiment, X¹ in the general formula (1) is preferably a nitrogen atom, which has a high value of atomic refraction, from the viewpoint of obtaining a compound having a high refractive index.

That is, in the present embodiment, the polymerizable compound can have the following structures.

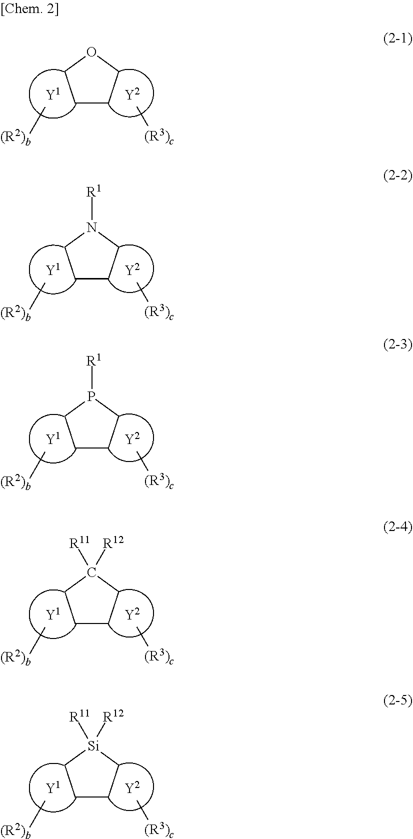

In the general formulas (2-1) to (2-5), Y¹ and Y² each represent a benzene ring or a naphthalene ring. Y¹ and Y² may simultaneously represent a benzene ring, or a case may be excluded in which Y¹ and Y² simultaneously represent a benzene ring. In order to obtain a high refractive index modulation degree (Δn) without a heating step after exposure, at least one of Y¹ or Y² preferably represents a naphthalene ring, and both Y¹ and Y² more preferably represent a naphthalene ring. In a case where Y¹ and/or Y² represents a benzene ring, b or c corresponding to Y¹ and/or Y² representing the benzene ring is 4. In a case where Y¹ and/or Y² represents a naphthalene ring, b and/or c corresponding to Y¹ and/or Y² representing the naphthalene ring is 6.

R¹, R², R³, R¹¹, and R¹² each represent hydrogen or a substituent represented by *-Z¹ (R⁴)_{d} (in which * represents a binding site). In a case where a plurality of R¹s, a plurality of R²s, and a plurality of R³s are present, the plurality of R¹s, the plurality of R²s, and the plurality of R³s may be of an identical kind or of different kinds, and all of R¹s, R²s, R³s, R¹¹s, and R¹²s in the general formulas (2-1) to (2-5) are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may contain an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of an identical kind or of different kinds, and all of the plurality of R⁴s in the general formulas (2-1) to (2-5) is not simultaneously hydrogen.

Furthermore, in the general formula (1), Y¹ and Y² each represent a benzene ring or a naphthalene ring. Y¹ and Y² may simultaneously represent a benzene ring, or a case may be excluded in which Y¹ and Y² simultaneously represent a benzene ring. In order to obtain a high refractive index modulation degree (Δn) without a heating step after exposure, at least one of Y¹ or Y² preferably represents a naphthalene ring, and both Y¹ and Y² more preferably represent a naphthalene ring.

The molecular refraction of phenyl (C₆H₅) and naphthyl (C₁₀H₇) is as follows. Phenyl (C₆H₅): 25.5, naphthyl (C₁₀H₇): 43.3 (Optical Review, Vol. 44, No. 8, 2015, p. 298-303). In the present embodiment, Y¹ and Y² each preferably represent a naphthalene ring, which has a high value of molecular refraction, from the viewpoint of obtaining a compound having a high refractive index.

That is, in the present embodiment, the polymerizable compound can have the following structures.

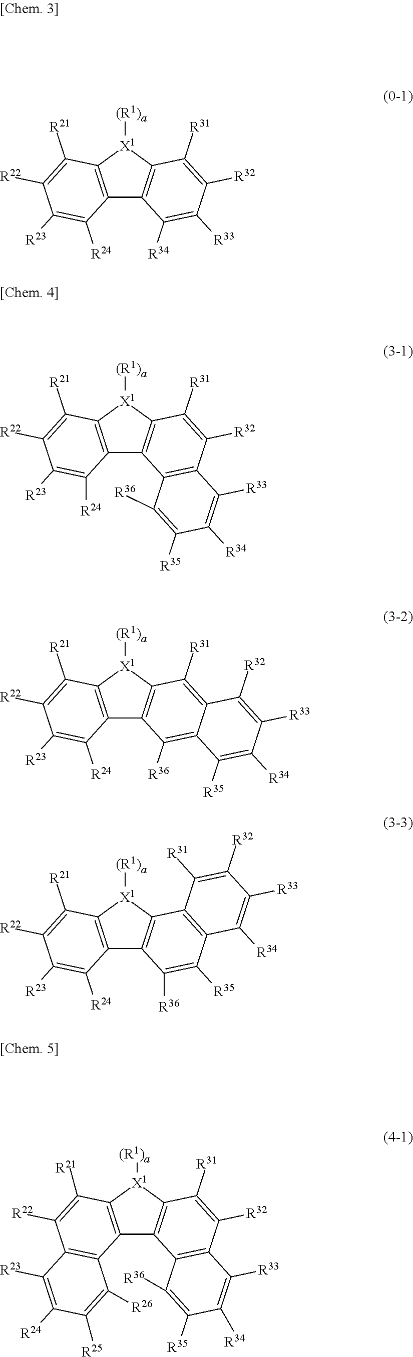

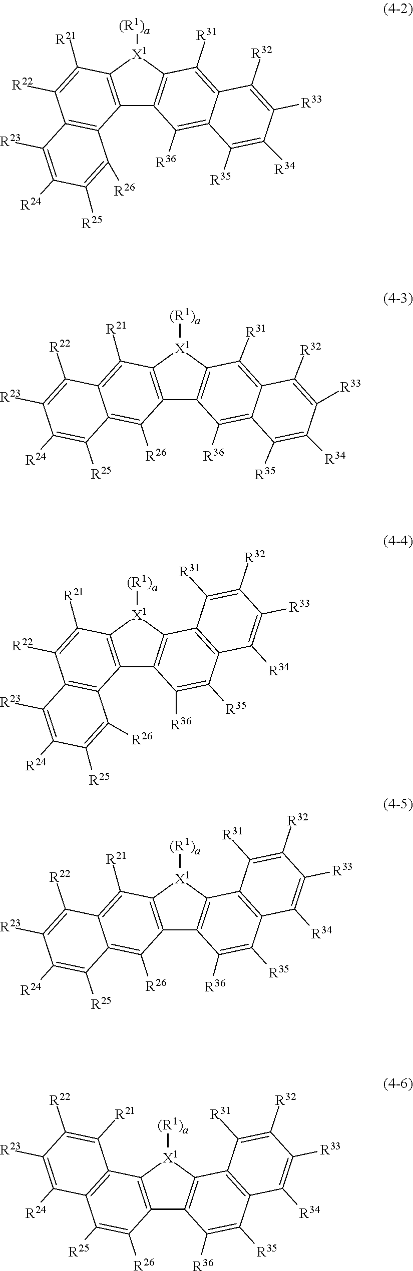

In the general formulas (0-1), (3-1) to (3-3), and (4-1) to (4-6), X¹ represents an oxygen atom, a nitrogen atom, a phosphorus atom, a carbon atom, or a silicon atom. In a case where X¹ represents an oxygen atom, a is 0, in a case where X¹ represents a nitrogen atom or a phosphorus atom, a is 1, and in a case where X¹ represents a carbon atom or a silicon atom, a is 2.

R¹, R²¹ to R²⁶, and R³¹ to R³⁶ each represent hydrogen or a substituent represented by *-Z¹ (R⁴)_{d} (in which * represents a binding site). R¹, R²¹ to R²⁶, and R³¹ to R³⁶ may be of an identical kind or of different kinds. Furthermore, in a case where a plurality of R¹s is present, the plurality of R¹s may of an identical kind or of different kinds. However, R¹, R²¹ to R²⁶, and R³¹ to R³⁶ in the general formulas (0-1), (3-1) to (3-3), and (4-1) to (4-6) are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may contain an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of an identical kind or of different kinds, and all of the plurality of R⁴s in the general formulas (0-1), (3-1) to (3-3), and (4-1) to (4-6) is not simultaneously hydrogen.

In the general formula (1), Z¹ represents a single bond, a divalent or higher saturated hydrocarbon group, or a divalent or higher unsaturated hydrocarbon group. The saturated hydrocarbon group or the unsaturated hydrocarbon group may contain an ether bond and/or a thioether bond.

In a case where Z¹ is a divalent or higher saturated hydrocarbon group, the saturated hydrocarbon group may be a linear, branched, or cyclic substituted or unsubstituted hydrocarbon group. In general, the larger simple carbon chain number an organic compound has, the more easily the organic compound tends to obtain solubility. Meanwhile, the larger simple carbon chain number an organic compound has, the lower refractive index the organic compound tends to have. Therefore, the saturated hydrocarbon group preferably has a simple carbon chain number of 1 to 15, and more preferably 1 to 10.

Furthermore, in a case where Z¹ is a divalent or higher unsaturated hydrocarbon group, the unsaturated hydrocarbon group may be a linear, branched, or cyclic substituted or unsubstituted hydrocarbon group or an aromatic group. The unsaturated hydrocarbon group preferably has a simple carbon chain number of 1 to 15, and more preferably 1 to 10. In a case where the unsaturated hydrocarbon group contains an aromatic group, the aromatic group is preferably a substituted or unsubstituted divalent or higher aromatic group represented by the chemical formulas (5-1) to (5-8) described below. Four or more benzene rings linearly connected absorb light in the visible light region and have a color, and therefore may be undesirable from the viewpoint of transparency. Therefore, the aromatic group preferably does not have a structure in which four or more benzene rings are linearly arranged, and the aromatic group preferably has a linear shape including a benzene ring, a naphthalene ring, or an anthracene ring.

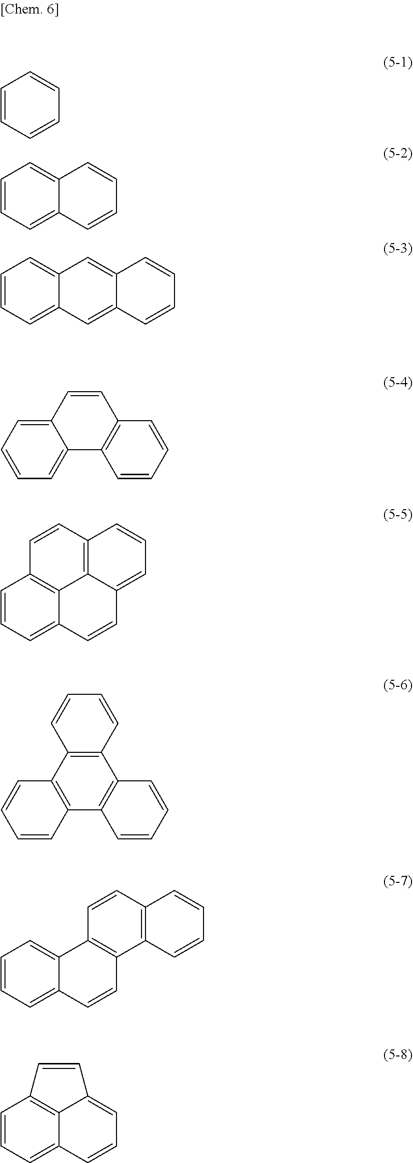

In the general formula (1), examples of the polymerizable substituent represented by R⁴ include those including a polymerizable unsaturated group and those including a reactive substituent. Examples of the polymerizable substituents including a polymerizable unsaturated group include a vinyl group, an acrylic group, a methacrylic group, an acrylamide group, a methacrylamide group, a cyanoacrylate group, a cyanomethacrylate group, a vinyl ether group, a vinyl cyanide group, a vinyl nitrate group, conjugated polyene groups, vinyl halide groups, vinyl ketone groups, a styryl group, and the like. Examples of the polymerizable substituents including a reactive substituent include an epoxy group, an oxetane group, a hydroxyl group, an amino group, a carboxyl group, acid anhydride groups, acid halide groups, an isocyanate group, and the like.

In the general formula (1), X¹ preferably represents a nitrogen atom, and Y¹ and Y² each preferably represent a naphthalene ring. That is, the above-described compound is preferably represented by the general formula (1-1) described below.

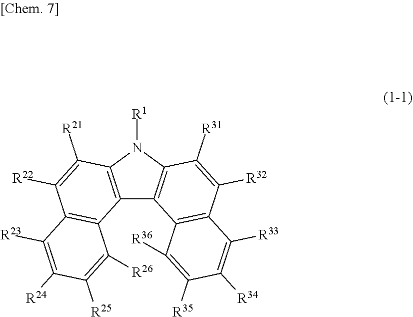

In the general formula (1-1) , R¹, R²¹ to R²⁶, and R³¹ to R³⁶ represent hydrogen or a substituent represented by *-Z¹ (R⁴)_{d} (in which * represents a binding site). R¹, R²¹ to R²⁶, and R³¹ to R³⁶ may be of an identical kind or of different kinds. However, R¹, R²¹ to R²⁶, and R³¹ to R³⁶ are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may contain an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of an identical kind or of different kinds, and all of the plurality of R⁴s in the general formula (1-1) is not simultaneously hydrogen.

In the general formula (1-1), R¹ is preferably a substituent represented by *-Z¹ (R⁴)_{d} (in which * represents a binding site) , and R²¹ to R²⁶ and R³¹ to R³⁶ preferably represent hydrogen.

Furthermore, in the general formula (1), X¹ preferably represents a carbon atom, and Y¹ and Y² each preferably represent a naphthalene ring. That is, the above-described compound is preferably represented by the general formula (1-2) described below.

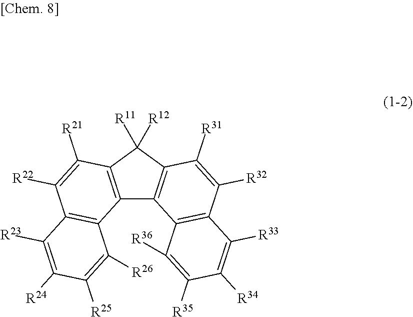

In the general formula (1-2) , R¹¹, R¹², R²¹ to R²⁶, and R³¹ to R³⁶ represent hydrogen or a substituent represented by *-Z¹ (R⁴)_{d} (in which * represents a binding site). R¹¹, R¹², R²¹ to R²⁶, and R³¹ to R³⁶ may be of an identical kind or of different kinds. However, R¹¹, R¹², R²¹ to R²⁶, and R³¹ to R³⁶ in the general formula (1-2) are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may contain an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of an identical kind or of different kinds, and all of the plurality of R⁴s in the general formula (1-2) is not simultaneously hydrogen.

In the general formula (1-2), R¹¹ and/or R¹² is preferably a substituent represented by *-Z¹ (R⁴)_{d} (in which * represents a binding site) , and R²¹ to R²⁶ and R³¹ to R³⁶ preferably represent hydrogen.

A preferred monofunctional exemplary compound of the polymerizable compound of the present embodiment has the following chemical structural formula.

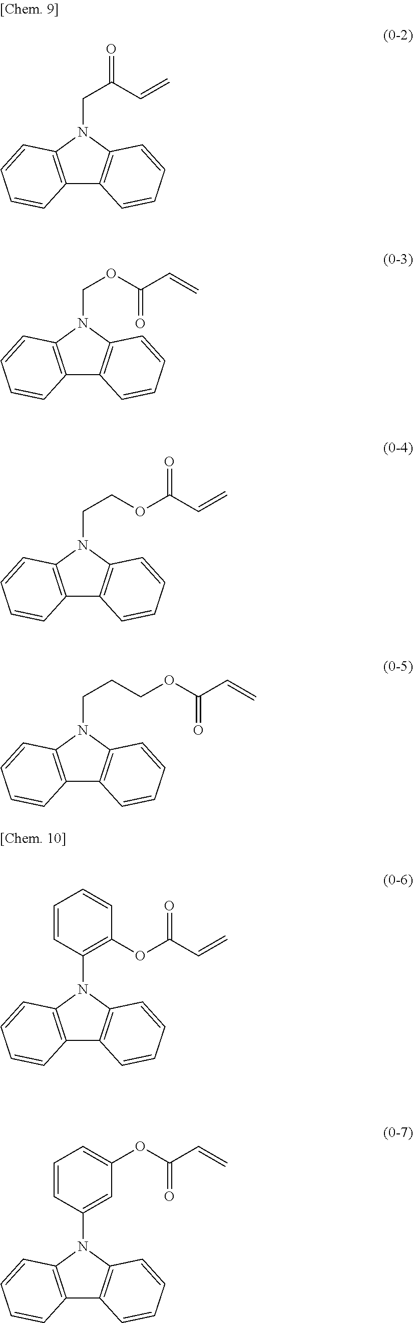 [SMILES: C=CC(=O)Cn1c2ccccc2c2ccccc21 ; C=CC(=O)OCn1c2ccccc2c2ccccc21 ; C=CC(=O)OCCn1c2ccccc2c2ccccc21 ; C=CC(=O)OCCCn1c2ccccc2c2ccccc21 ; C=CC(=O)Oc1ccccc1-n1c2ccccc2c2ccccc21 ; C=CC(=O)Oc1cccc(-n2c3ccccc3c3ccccc32)c1]

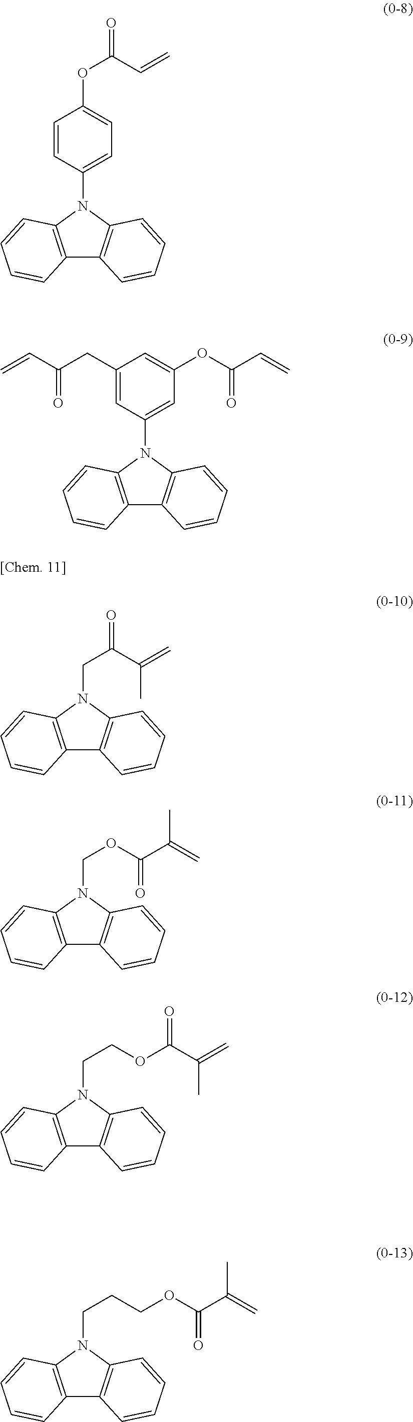

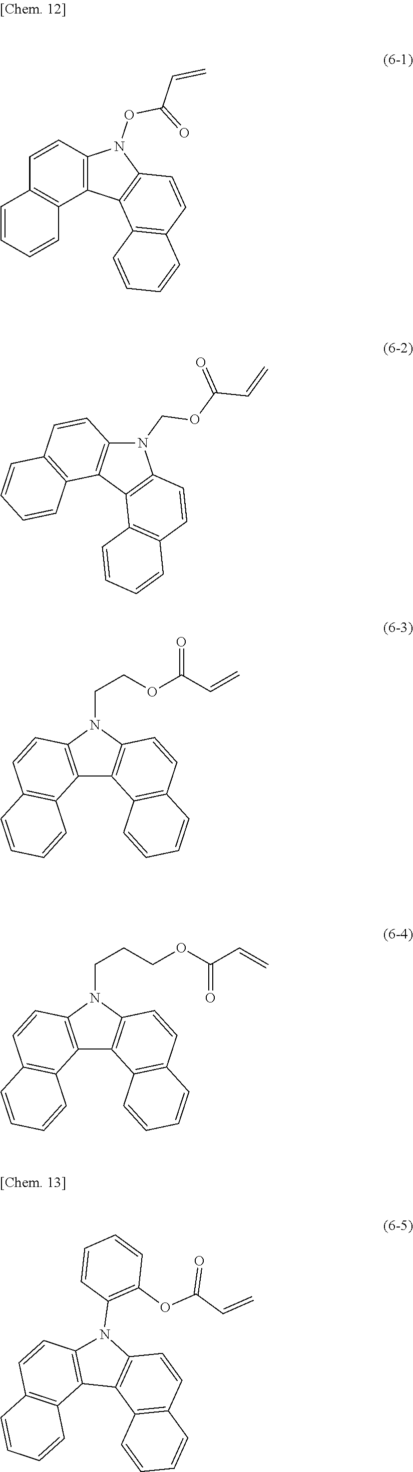 [SMILES: C=CC(=O)On1c2ccc3ccccc3c2c2c3ccccc3ccc21 ; C=CC(=O)OCn1c2ccc3ccccc3c2c2c3ccccc3ccc21 ; C=CC(=O)OCCn1c2ccc3ccccc3c2c2c3ccccc3ccc21 ; C=CC(=O)OCCCn1c2ccc3ccccc3c2c2c3ccccc3ccc21 ; C=CC(=O)Oc1ccccc1-n1c2ccc3ccccc3c2c2c3ccccc3ccc21]

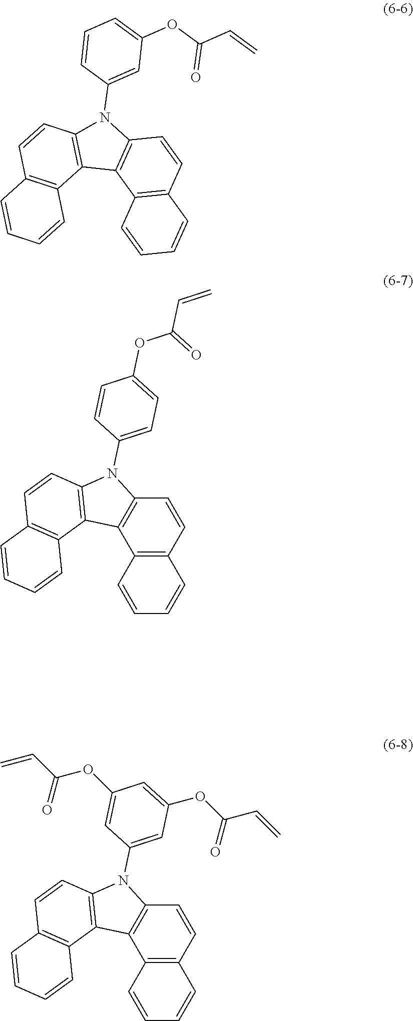

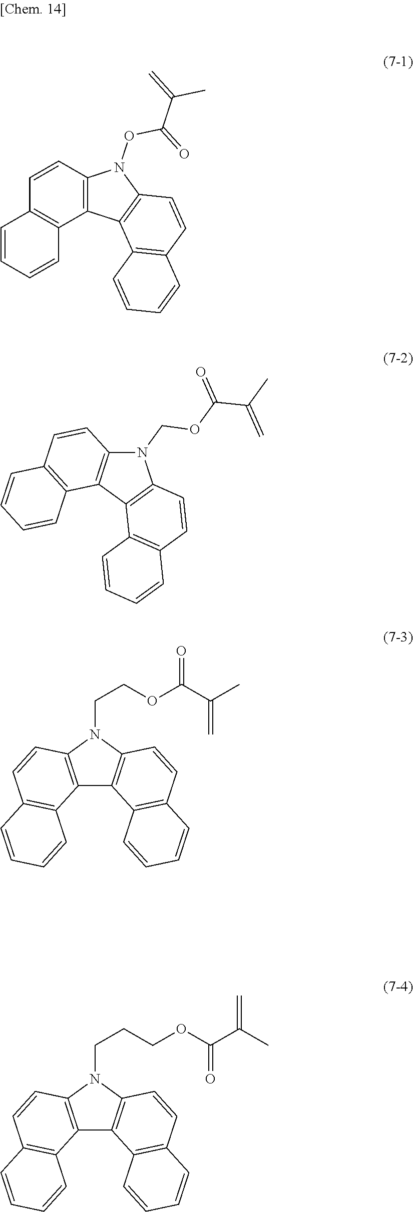 [SMILES: C=C(C)C(=O)On1c2ccc3ccccc3c2c2c3ccccc3ccc21 ; C=C(C)C(=O)OCn1c2ccc3ccccc3c2c2c3ccccc3ccc21 ; C=C(C)C(=O)OCCn1c2ccc3ccccc3c2c2c3ccccc3ccc21 ; C=C(C)C(=O)OCCCn1c2ccc3ccccc3c2c2c3ccccc3ccc21]

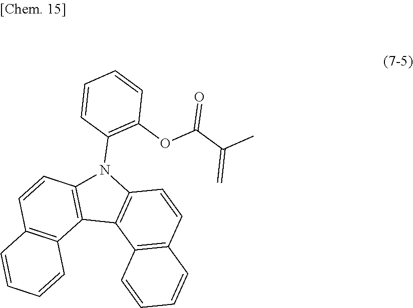 [SMILES: C=C(C)C(=O)Oc1ccccc1-n1c2ccc3ccccc3c2c2c3ccccc3ccc21]

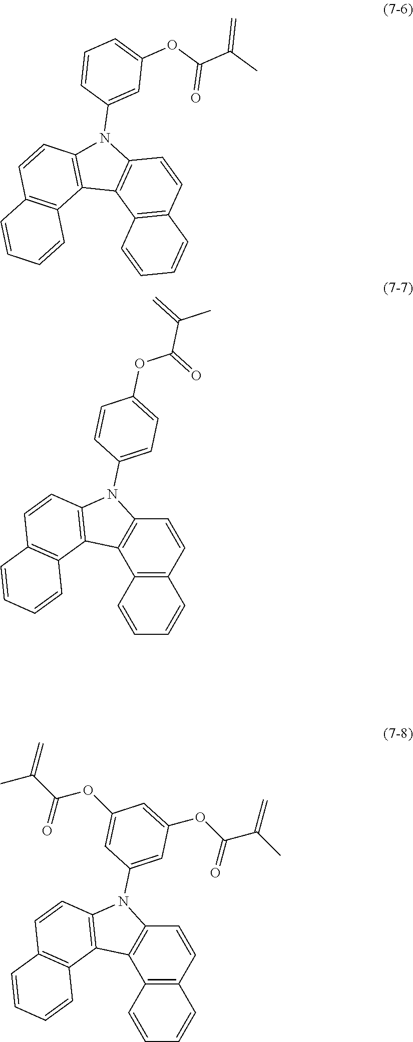

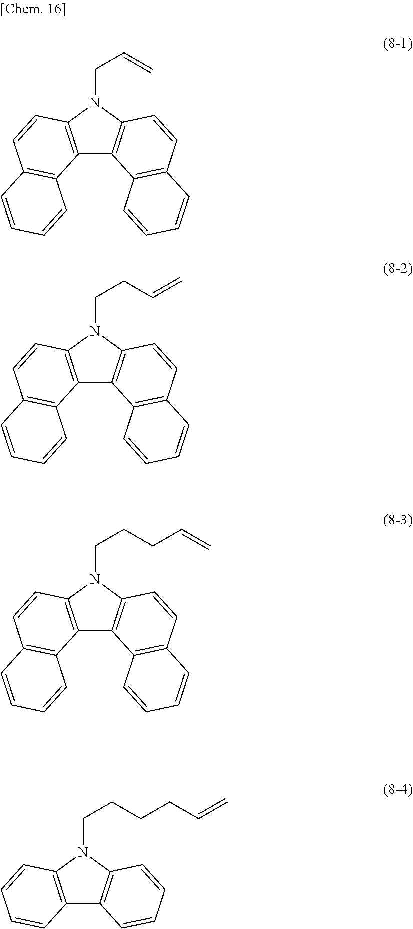 [SMILES: C=CCn1c2ccc3ccccc3c2c2c3ccccc3ccc21 ; C=CCCn1c2ccc3ccccc3c2c2c3ccccc3ccc21 ; C=CCCCn1c2ccc3ccccc3c2c2c3ccccc3ccc21 ; C=CCCCCn1c2ccccc2c2ccccc21]

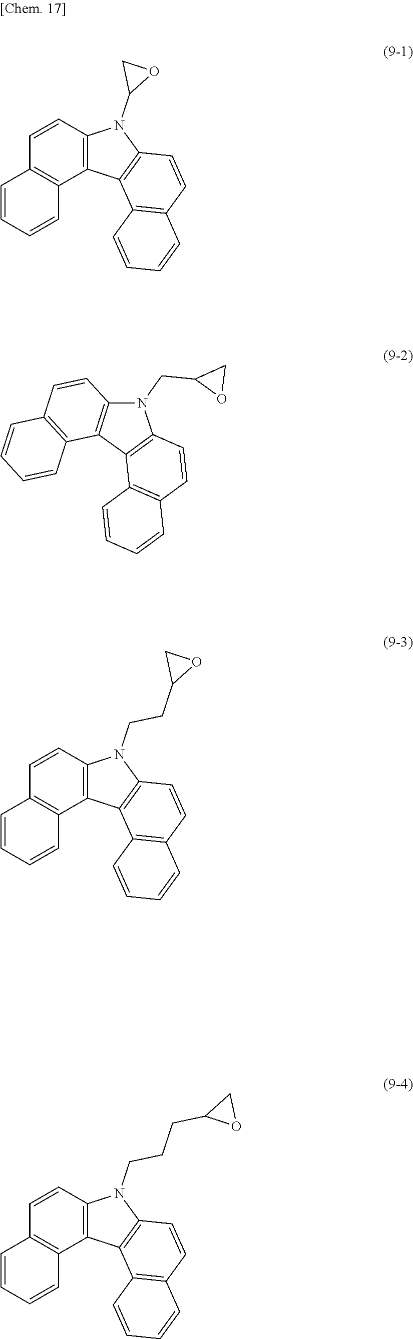 [SMILES: c1ccc2c(c1)ccc1c2c2c3ccccc3ccc2n1C1CO1 ; c1ccc2c(c1)ccc1c2c2c3ccccc3ccc2n1CC1CO1 ; c1ccc2c(c1)ccc1c2c2c3ccccc3ccc2n1CCC1CO1 ; c1ccc2c(c1)ccc1c2c2c3ccccc3ccc2n1CCCC1CO1]

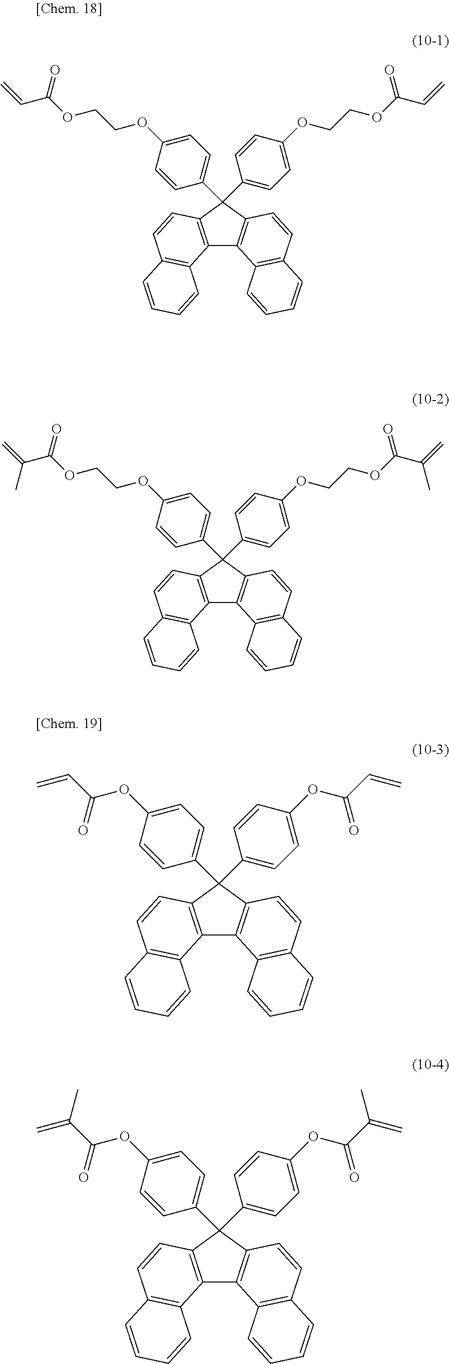

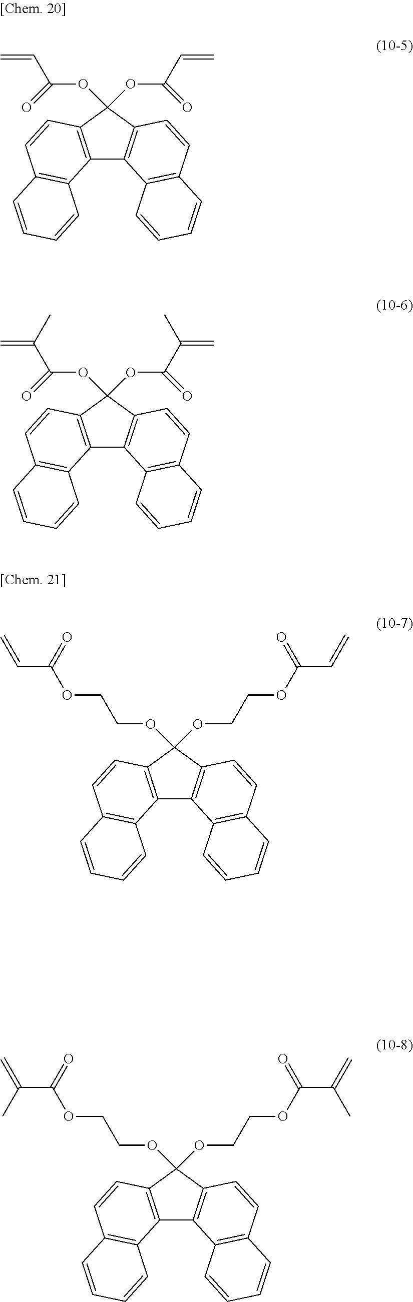

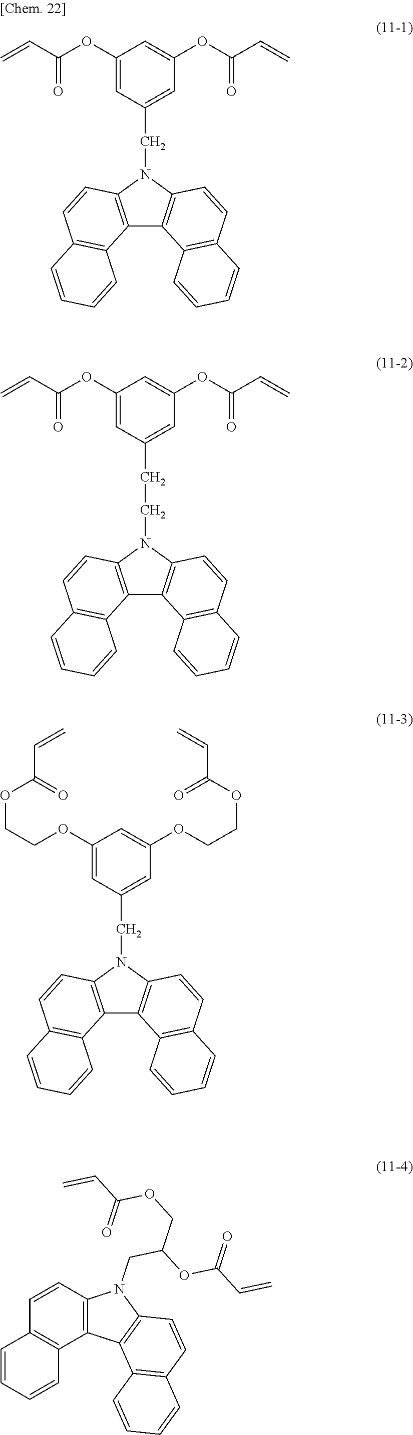

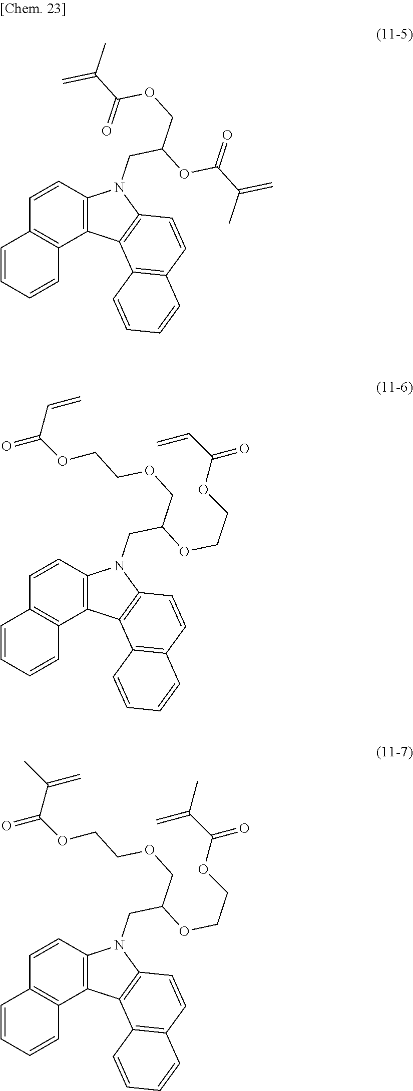 [SMILES: C=C(C)C(=O)OCC(Cn1c2ccc3ccccc3c2c2c3ccccc3ccc21)OC(=O)C(=C)C ; C=CC(=O)OCCOCC(Cn1c2ccc3ccccc3c2c2c3ccccc3ccc21)OCCOC(=O)C=C ; C=C(C)C(=O)OCCOCC(Cn1c2ccc3ccccc3c2c2c3ccccc3ccc21)OCCOC(=O)C(=C)C]

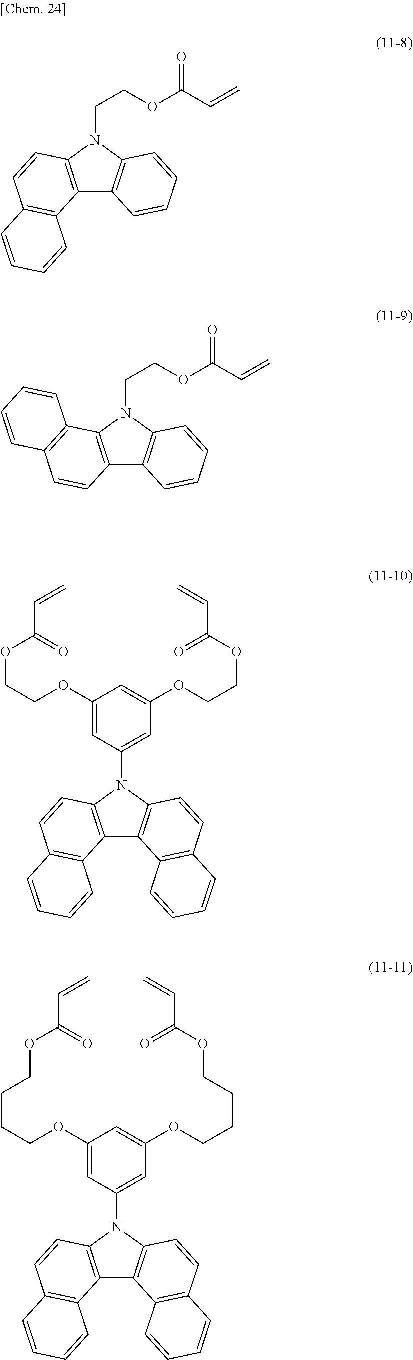 [SMILES: C=CC(=O)OCCn1c2ccccc2c2c3ccccc3ccc21 ; C=CC(=O)OCCn1c2ccccc2c2ccc3ccccc3c21 ; C=CC(=O)OCCOc1cc(OCCOC(=O)C=C)cc(-n2c3ccc4ccccc4c3c3c4ccccc4ccc32)c1 ; C=CC(=O)OCCCCOc1cc(OCCCCOC(=O)C=C)cc(-n2c3ccc4ccccc4c3c3c4ccccc4ccc32)c1]

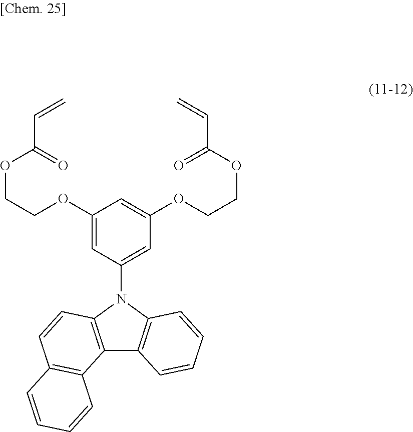 [SMILES: C=CC(=O)OCCOc1cc(OCCOC(=O)C=C)cc(-n2c3ccccc3c3c4ccccc4ccc32)c1]

In the present embodiment, the polymerizable compound preferably has a refractive index of 1.60 or more, more preferably 1.65 or more, and still more preferably 1.70 or more. Meanwhile, the refractive index of the polymerizable compound is, for example, 1.80 or less, but may be more than 1.80.

Note that the refractive index can be measured with a critical angle method or a spectroscopic ellipsometry method. For example, in the critical angle method, the refractive index can be measured using an Abbe refractometer ER-1 manufactured by ERMA INC. (using a measurement wavelength of 486 nm, 589 nm, 656 nm, or the like in the visible light region).

### Polymerization Initiator

The polymerization initiator contains an electron-donating initiator and an electron-accepting initiator. If the polymerization initiator contains an electron-donating initiator and an electron-accepting initiator, the in-plane uniformity of a diffraction peak wavelength can be high even in a case where the initial maximum load on the protective layer 12 measured in a tensile test is 3 N or more. The reason why such an effect is exhibited is considered as follows. If an electron-donating initiator and an electron-accepting initiator are contained as the polymerization initiator, the efficiency of generating a radical active species by irradiation with light is increased to cure the photosensitive layer 11 quickly, and thus the photosensitive layer 11 can be restrained from deforming due to cure shrinkage stress, so that even in a case where the initial maximum load on the protective layer 12 measured in a tensile test is 3 N or more, deformation unevenness of the hologram recording medium 10 can be restrained from occurring in the in-plane direction of the hologram recording medium 10.

The electron-donating initiator and the electron-accepting initiator may be a thermal polymerization initiator or a photopolymerization initiator, or may be used in combination of a thermal polymerization initiator and a photopolymerization initiator. Examples of the thermal polymerization initiator and the photopolymerization initiator may include radical polymerization initiators (radical generators), cationic polymerization initiators (acid generators), and polymerization initiators having both of the functions of a radical generator and an acid generator. Note that an anionic polymerization initiator (base generator) may be used as the thermal polymerization initiator and the photopolymerization initiator.

The electron-donating initiator is preferably an organic boron salt-based initiator. Examples of the organic boron salt-based initiator being available include tetrabutylammonium=butyltriphenylborate (manufactured by Showa Denko K.K., product name: P3B) and tetrabutylammonium=butyltrinaphthylborate (manufactured by Showa Denko K.K., product name: N3B).

The electron-accepting initiator is preferably an onium salt-based initiator. Examples of the onium salt-based initiator being available include salts containing a diphenyliodonium cation and salts containing a triphenylsulfonium cation. Examples of the onium salt-based initiator being available include 4-isopropyl-4′-methyldiphenyliodonium tetrakis(pentafluorophenyl)borate (manufactured by Tokyo Chemical Industry Co., Ltd., product name: I0591), (2-methylphenyl) (2,4,6-trimethylphenyl)iodonium trifluoromethanesulfonate mesityl(o-tolyl)iodonium triflate (manufactured by Tokyo Chemical Industry Co., Ltd., product name: M2907), (4-methylphenyl) (2,4,6-trimethylphenyl)iodonium trifluoromethanesulfonate mesityl(p-tolyl)iodonium triflate (manufactured by Tokyo Chemical Industry Co., Ltd., product name: M2909), a triarylsulfonium borate salt (manufactured by BASF, product name: IRAGACURE 290), tri-p-tolylsulfonium hexafluorophosphate (manufactured by Tokyo Chemical Industry Co., Ltd., product name: T2041), diphenyl 4-thiophenoxyphenylsulfonium hexafluorophosphate (manufactured by San-Apro Ltd., product name: CPI-100P), diphenyl-4-thiophenoxyphenylsulfonium tetrakis(pentafluorophenyl)borate (manufactured by San-Apro Ltd., product name: CPI-100B), a triarylsulfonium borate salt (manufactured by San-Apro Ltd., product name: CPI-200K), and a triarylsulfonium borate salt (manufactured by San-Apro Ltd., product name: CPI-310B).

### Binder Resin

The binder resin can be effective for improving the film strength and improving the heat resistance and the mechanical strength. The binder resin is not particularly limited, and any binder resin can be used.

Examples of the binder resin include vinyl acetate-based resins such as polyvinyl acetate, its hydrolyzates, and the like; acrylic resins such as poly(meth)acrylic acid esters, partial hydrolyzates thereof, and the like; polyvinyl alcohol and its partial acetalized products; triacetyl cellulose; polyisoprene; polybutadiene; polychloroprene; silicone rubber; polystyrene; polyvinyl butyral; polychloroprene; polyvinyl chloride; polyarylate; chlorinated polyethylene; chlorinated polypropylene; poly-N-vinylcarbazole and its derivatives; poly-N-vinylpyrrolidone and its derivatives; polyarylate; copolymers of styrene and maleic anhydride and half-esters thereof; copolymers containing at least one in the copolymerizable monomer group including acrylic acid, acrylic acid esters, methacrylic acid, methacrylic acid esters, acrylamide, acrylonitrile, ethylene, propylene, vinyl chloride, vinyl acetate, and the like as a polymerization component; and the like, and one or more of these can be used. Moreover, as the copolymerization component, a monomer can also be used that contains a curable functional group that can be cured by heat or light.

Furthermore, an oligomer-type curable resin can also be used as the binder resin. Examples of the oligomer-type curable resin include epoxy compounds produced by condensation reactions of various phenol compounds such as bisphenol A, bisphenol S, novolac, o-cresol novolac, p-alkylphenol novolac, and the like with epichlorohydrin, and one or more of these can be used.

### Other Components

The photosensitive composition may contain, in addition to the above-described components, at least one selected from the group consisting of radical polymerizable monomers other than the compounds represented by the general formula (1), sensitizing dyes, inorganic fine particles, plasticizers, chain transfer agents, polymerization inhibitors, UV sensitizers, and the like.

Examples of the radical polymerizable monomers other than the compounds represented by the general formula (1) include monofunctional or polyfunctional carbazole-based monomers, dinaphthothiophene-based monomers, fluorene-based monomers, dibenzofuran-based monomers, and the like, and one or more of these can be used.

The sensitizing dye can increase the sensitivity of the polymerization initiator to light. The sensitizing dye may contain either or both of a dye that absorbs light in the visible light region and a UV sensitizing dye to be added for the purpose of improving light efficiency at the time of UV irradiation (such as an anthracene compound or the like). Furthermore, only one kind of sensitizing dye may be used, or a plurality of kinds of sensitizing dyes may be used to respond to a plurality of wavelengths.

The sensitizing dye is not particularly limited, and examples of the sensitizing dye include thiopyrylium salt-based dyes, merocyanine-based dyes, quinoline-based dyes, rose bengal-based dyes, styryl quinoline-based dyes, ketocoumarin-based dyes, thioxanthene-based dyes, xanthene-based dyes, thiazine-based dyes, azine-based dyes, phenazine-based dyes, oxonol-based dyes, cyanine-based dyes, rhodamine-based dyes, pyrylium salt-based dyes, cyclopentanone-based dyes, cyclohexanone-based dyes, and the like. Specific examples of the cyanine and merocyanine-based dyes include 3,3′-dicarboxyethyl-2,2′-thiocyanine bromide, 1-carboxymethyl-1′-carboxyethyl-2,2′-quinocyanine bromide, 1,3′-diethyl-2,2′-quinothiacyanine iodide, 3-ethyl-5-[(3-ethyl-2(3H)-benzothiazolylidene)ethylidene]-2-thioxo-4-oxazolidine, and the like, specific examples of the coumarin and ketocoumarin-based dyes include 3-(2′-benzimidazole)-7-diethylaminocoumarin, 3,3′-carbonylbis(7-diethylaminocoumarin), 3,3′-carbonylbiscoumarin, 3,3′-carbonylbis(5,7-dimethoxycoumarin), 3,3′-carbonylbis(7-acetoxycoumarin), 2,3-dihydro-1,3,3-trimethyl-2-[2-(2-methyl-3H-indole-3-ylidene)ethylidene]-1H-indole, and the like, specific examples of the thiazine-based dyes include methylene blue and the like, specific examples of the azine-based dyes include Safranin O and the like, and specific examples of the cyclopentanone-based dyes include (2E,5E)-2,5-bis[(4-(dimethylamino)phenyl)methylene]cyclopentanone, (2E,5E)-2,5-bis[(4-(diethylamino)phenyl)methylene]cyclopentanone, and the like, and one or more of these can be used.

The inorganic fine particles are not particularly limited, and for example, TiO₂ fine particles or ZrO₂ fine particles can be used. The photosensitive composition in the present embodiment may contain one kind of inorganic fine particles or two or more kinds of inorganic fine particles. For example, the TiO₂ fine particles and the ZrO₂ fine particles may be used in combination.

The plasticizer is effective for adjustment of the adhesion, the flexibility, the hardness, and other physical characteristics of the photosensitive composition.

The plasticizer is not particularly limited, and examples of the plasticizer include triethylene glycol, triethylene glycol diacetate, triethylene glycol dipropionate, triethylene glycol dicaprylate, triethylene glycol dimethyl ether, poly(ethylene glycol), poly(ethylene glycol) methyl ether, triethylene glycol bis(2-ethylhexanoate), tetraethylene glycol diheptanoate, diethyl sebacate, dibutyl suberate, tris(2-ethylhexyl)phosphate, isozorobyl naphthalene, diisopropyl naphthalene, poly(propylene glycol), glyceryl tributyrate, diethyl adipate, diethyl sebacate, monobutyl suberate, tributyl phosphate, tris(2-ethylhexyl)phosphate, and the like, and one or more of these can be used.

Furthermore, the plasticizer may have a polymerizable reactive group. The plasticizer is not particularly limited, and for example, a cationic polymerizable compound can be used. The cationic polymerizable compound is not particularly limited, and examples of the cationic polymerizable compound include epoxy compounds and oxetane compounds.

As the epoxy compound, for example, a glycidyl ether or the like can be used. Specific examples of the glycidyl ether include allyl glycidyl ether, phenyl glycidyl ether, 1,4-butanediol diglycidyl ether, 1,5-pentanediol diglycidyl ether, 1,6-hexanediol diglycidyl ether, 1,8-octanediol diglycidyl ether, 1,10-decanediol diglycidyl ether, 1,12-dodecanediol diglycidyl ether, ethylene glycol diglycidyl ether, diethylene glycol diglycidyl ether, polyethylene glycol diglycidyl ether, polypropylene glycol diglycidyl ether, neopentyl glycol diglycidyl ether, bisphenol A diglycidyl ether, bisphenol F diglycidyl ether, trimethylolpropane diglycidyl ether, glycerin triglycidyl ether, diglycerol triglycidyl ether, sorbitol polyglycidyl ether, pentaerythritol polyglycidyl ether, and the like, and one or more of these can be used.

Examples of the oxetane compound include 3-ethyl-3-hydroxymethyloxetane, 2-ethylhexyloxetane, xylylene bisoxetane, 3-ethyl-3{[(3-ethyloxetane-3-yl)methoxy]methyl}oxetane, 2-hydroxyethyl vinyl ether, 4-hydroxybutyl vinyl ether, diethylene glycol monovinyl ether, 2-ethylhexyl vinyl ether, and the like, and one or more of these can be used.

The chain transfer agent extracts a radical from the growth terminal of the polymerization reaction to stop the growth, and serves as a new polymerization reaction-initiating species to be add to the radical polymerizable monomer, and thus can start the growth of a new polymer. Use of the chain transfer agent increases the frequency of chain transfer of radical polymerization, so that the reaction rate of the radical polymerizable monomer increases, and the sensitivity to light can be improved. Furthermore, increase in the reaction rate of the radical polymerizable monomer increases components contributing to the reaction, and thus the degree of polymerization of the radical polymerizable monomer can be adjusted.

The chain transfer agent is not particularly limited, and examples of the chain transfer agent include a-methylstyrene dimer, 2-mercaptobenzoxazole, 2-mercaptobenzothiazole, tert-butyl alcohol, n-butanol, isobutanol, isopropylbenzene, ethylbenzene, chloroform, methyl ethyl ketone, propylene, vinyl chloride, and the like, and one or more of these can be used.

The polymerization inhibitor is not particularly limited, and examples of the polymerization inhibitor include quinone-based compounds such as hydroquinone and the like; hindered phenol-based compounds; benzotriazole compounds; thiazine-based compounds such as phenothiazine and the like; and the like, and one or more of these can be used.

The UV sensitizer is not particularly limited, and for example, an anthracene-based compound or the like can be used.

### Release Layer

The release layer 13 is provided on the other surface (second surface) of the photosensitive layer 11. The release layer 13 may be a support that supports the hologram recording medium 10. The release layer 13 is included so as to be peelable from the photosensitive layer 11. The release layer 13 may be a film or a substrate having rigidity, but is preferably a substrate in consideration of the peelability of the hologram recording medium 10 from the release layer 13. The substrate is preferably a glass substrate. The release layer 13 has transparency to visible light or the like. In order to facilitate release of the hologram recording medium 10 from the release layer 13, the surface to be bonded to the photosensitive layer 11 may be release-treated.

### Method of Manufacturing Hologram Recording Medium

Hereinafter, an example of a method of manufacturing the hologram recording medium 10 according to the first embodiment will be described.

### Preparation of Photosensitive Composition

Predetermined amounts of a compound represented by the general formula (1), a polymerization initiator, and a binder resin are each weighed out, added to a solvent at normal temperature or the like, and dissolved and mixed to prepare a photosensitive composition as a coating liquid. Furthermore, at least one selected from the group consisting of radical polymerizable monomers other than the compounds represented by the general formula (1), sensitizing dyes, inorganic fine particles, plasticizers, chain transfer agents, polymerization inhibitors, UV sensitizers, and the like may be added according to the use, the purpose, and the like.

Examples of the solvent include acetone, xylene, toluene, methyl ethyl ketone, tetrahydrofuran, benzene, methylene chloride, dichloromethane, chloroform, methanol, ethanol, and the like, and one or more of these can be used. The solvent can be effective for adjusting the viscosity and the compatibility, and in addition, for improving the film-formability and the like.

### Step of Forming Photosensitive Layer

The prepared photosensitive composition is applied onto a protective layer 12, and then dried to form a photosensitive layer 11. In the method of applying, for example, a spin coater, a gravure coater, a comma coater, a bar coater, or the like can be used. As described above, an intended hologram recording medium 10 can be obtained.

### Operation and Effect

As described above, in the hologram recording medium 10 according to the first embodiment, the initial maximum load on the protective layer 12 measured in a tensile test is 3 N or more and 1000 N or less, and the photosensitive layer 11 contains, as a polymerizable initiator, an electron-donating initiator and an electron-accepting initiator. As a result, the hologram recording medium 10 is obtained that can have high in-plane uniformity of a diffraction peak wavelength after exposure and can be peeled off from a release layer 13 after exposure.

In a case where the photosensitive layer 11 contains the compound represented by the general formula (1), a high refractive index modulation degree (Δn) can be obtained without a heating step after exposure. In a case where Y¹ and Y² each represent a naphthalene ring in the general formula (1), the refractive index modulation degree (Δn) can be particularly high.

### 3 Second Embodiment

### Configuration of Hologram Optical Element

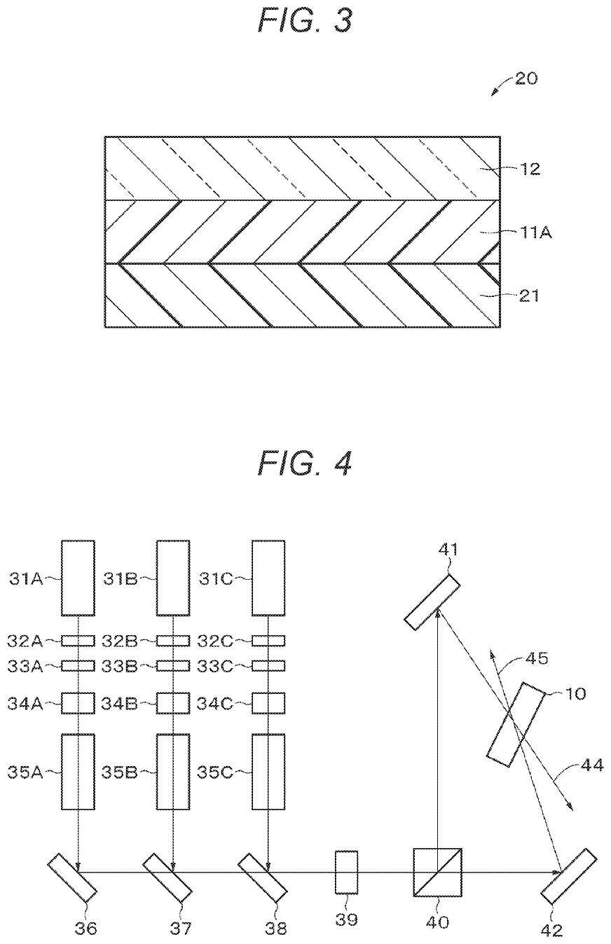

FIG. 3 is a cross-sectional view illustrating an example of a configuration of a hologram optical element 20 according to a second embodiment of the present disclosure. Note that, in the second embodiment, a portion similar to that in the first embodiment is numbered with the same reference sign as that in the first embodiment, and the description of such a portion is omitted. As illustrated in FIG. 3, the hologram optical element 20 may be supported on a support 21.

The hologram optical element 20 according to the second embodiment of the present disclosure is obtained by exposing a hologram recording medium 10. The hologram optical element 20 includes a hologram layer 11A. The hologram layer 11A is an exposed photosensitive layer 11. The polymerizable compound contained in the hologram layer 11A is polymerized. The hologram layer 11A may contain, for example, a polymer and a polymerization initiator having a structure changed by irradiating the polymerization initiator with external energy to generate an active species. The polymer preferably contains a polymer of a compound represented by the general formula (1). The polymer preferably contains at least one of an acrylate polymer or a methacrylate polymer.

The hologram layer 11A may contain a binder resin. The hologram layer 11A may contain at least one of a plasticizer or a polymer of a plasticizer. The hologram layer 11A may contain at least one selected from the group consisting of polymers of a radical polymerizable monomer other than the compounds represented by the general formula (1), sensitizing dyes, inorganic fine particles, plasticizers, chain transfer agents, polymerization inhibitors, UV sensitizers, and the like.

The hologram optical element 20 according to the second embodiment is excellent in in-plane uniformity of a diffraction peak wavelength, and can be peeled off from a release layer 13 after exposure. Furthermore, the hologram optical element 20 of the present embodiment is excellent in transparency.

### Optical System for Hologram Recording

FIG. 4 is a schematic diagram illustrating an example of a configuration of an optical system for hologram recording used for exposure of the hologram recording medium 10. The optical system for hologram recording includes a diode-pumped solid-state laser 31A, a diode-pumped solid-state laser 31B, a diode-pumped solid-state laser 31C, electron shutters 32A, 32B, and 32C, half-wave plates 33A, 33B, and 33C, objective lenses 34A, 34B, and 34C, beam expanders 35A, 35B, and 35C, a mirror 36, a dichroic mirror 37, a dichroic mirror 38, an iris diaphragm 39, a beam splitter 40, a mirror 41, and a mirror 42.

The diode-pumped solid-state laser 31A emits red laser light having a peak wavelength of 660 nm. The red laser light emitted by the diode-pumped solid-state laser 31A is incident on the mirror 36 via the electron shutter 32A, the half-wave plate 33A, the objective lens 34A, and the beam expander 35A. The red laser light reflected by the mirror 36 is incident on the beam splitter 40 via the dichroic mirror 37, the dichroic mirror 38, and the iris diaphragm 39.

The diode-pumped solid-state laser 31B emits green laser light having a peak wavelength of 532 nm. The green laser light emitted by the diode-pumped solid-state laser 31B is incident on the dichroic mirror 37 via the electron shutter 32B, the half-wave plate 33B, the objective lens 34B, and the beam expander 35B. The dichroic mirror 37 reflects green laser light but transmits red laser light. The green laser light reflected by the dichroic mirror 37 is incident on the beam splitter 40 via the dichroic mirror 38 and the iris diaphragm 39.

The diode-pumped solid-state laser 31C emits blue laser light having a peak wavelength of 457 nm. The blue laser light emitted by the diode-pumped solid-state laser 31C is incident on the dichroic mirror 38 via the electron shutter 32C, the half-wave plate 33C, the objective lens 34C, and the beam expander 35C. The dichroic mirror 38 reflects blue laser light but transmits red laser light and green laser light. The blue laser light reflected by the dichroic mirror 38 is incident on the beam splitter 40 via the iris diaphragm 39.

Each color laser light incident on the beam splitter 40 is separated into a first light flux 44 and a second light flux 45. The separated first light flux 44 and second light flux 45 are reflected by the mirror 41 and the mirror 42, respectively, and thus the hologram recording medium 10 is irradiated with the first light flux 44 and the second light flux 45.

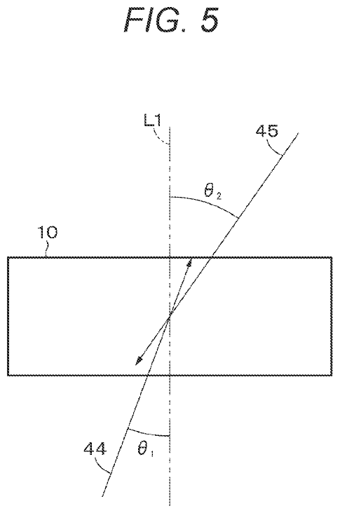

FIG. 5 is a schematic view of an optical system for hologram recording at the time of two-beam exposure. In the present description, an angle θ₁ formed by the first light flux 44 and a normal line L1 of the hologram recording medium 10 is defined as an “incident angle θ₁ of the first light flux 44”, and an angle θ₂ formed by the second light flux 45 and the normal line L1 of the hologram recording medium 10 is defined as an “incident angle θ₂ of the second light flux 45”.

### Method of Manufacturing Hologram Optical Element

The hologram optical element 20 according to the second embodiment of the present disclosure can be obtained, for example, by performing two-beam exposure on the hologram recording medium 10 according to the first embodiment of the present disclosure using a semiconductor laser in the visible light region, then irradiating the entire surface with UV (ultraviolet ray) to cure an uncured monomer or the like, and fixing the refractive index distribution in the hologram recording medium 10. In a case where the photosensitive layer 11 contains, for example, three kinds of sensitizing dyes, the diode-pumped solid-state lasers 31A, 31B, and 31C are used as a semiconductor layer. At the time of exposure, the hologram recording medium 10 may be bonded to the release layer 13. The conditions of the two-beam exposure may be appropriately set by those skilled in the art according to the use, the purpose, and the like of the hologram optical element 20, but the light intensity of one light flux on the hologram recording medium 10 is preferably set to 0.1 to 100 mW/cm², exposure is preferably performed for 1 to 1000 seconds, and interference exposure is desirably performed so that the angle formed by two light fluxes is 0.1 to 179.9 degrees.

### 4 Third Embodiment

### Optical Device and Optical Component

An optical device and an optical component of a third embodiment of the present disclosure include the hologram optical element 20 according to the second embodiment of the present disclosure. Examples of the optical device and the optical component include image display devices such as eyewears, holographic screens, transparent displays, head-mounted displays, head-up displays, and the like, imaging devices, imaging elements, color filters, diffractive lenses, light-guiding plates, spectral elements, hologram sheets, information recording media such as optical disks, magneto-optical disks, and the like, optical pickup devices, polarizing microscopes, sensors, and the like.

The optical device and the optical component of the third embodiment according to the present disclosure use the hologram optical element 20 excellent in in-plane uniformity of a diffraction peak wavelength and transparency. Therefore, an optical device and an optical component can be realized that have a high optical characteristic and high optical stability. Moreover, in a case where the present disclosure is used in a display, the display can have a high see-through property.

### 5 Fourth Embodiment

### Method for Forming Hologram Diffraction Grating

The present disclosure provides a method for forming a hologram diffraction grating, and the method includes selectively reacting, by using an electromagnetic ray having an amplitude modulated spatially, a hologram recording medium 10 including a photosensitive layer 11 containing a polymerizable compound containing a compound represented by the general formula (1), a binder resin, and a polymerization initiator. The method for forming a hologram diffraction grating is the interference exposure described in the second embodiment. Therefore, description of the method for forming a hologram diffraction grating is omitted. According to the method for forming a hologram diffraction grating, an effect is exhibited as described in the third embodiment.

### 6 Analysis Method

### Method of Analyzing Onium Salt-Based Initiator, Substance Derived Therefrom, and the Like

Examples of the method of analyzing an onium salt-based initiator (electron-accepting initiator) and a substance derived from the onium salt-based initiator that are contained in a hologram recording medium 10 or a hologram optical element 20 include, but are not limited to, the following analysis method 1 and analysis method 2.

### Analysis Method 1

### Analysis Method: LC-MS (liquid Chromatography Mass Spectrometry)

Target substances for analysis: anionic components of onium salts, and decomposition products and reactants derived therefrom

Measurement sample: sample obtained by collecting photosensitive layer 11 from hologram recording medium 10, or by collecting hologram layer 11A from hologram optical element 20 Note that details of the method of collecting these layers will be described later.

Details of measurement conditions of liquid chromatography (LC) and mass spectrometry (MS) are as follows.

### LC Measurement Conditions

Liquid chromatograph: Waters Aquity UPLC

Column: ACQUITY UPLC HSS-T3 (2.1 mm×100 mm, 1.8 μm)

Temperature: 40° C.

Flow rate: 0.3 mL/min

Mobile phase: A: 0.1% HCOOH aq. B: acetonitrile

Gradient: B: 40%-6 min-95% (6.8 min Hold)

Injection volume: Pos. 1.0 μL, Neg. 2.0 μL

### MS Measurement Conditions

Mass spectrometer: Waters Synapt HDMS System

Measured mass range: m/z 100-1000

Ionization mode: ESI (−) (capillary voltage: −3.0 kV)

Ion source temperature: 120° C.

Heated desorption gas: N₂ 500° C. 800 L/hr

Cone voltage: 40 V

Collision energy: 20, 40, 60 eV

Mass resolution: 10,000 FWHM (V-mode) at m/z 556 (+)

Mass calibration substance: leucine enkephalin 100 ppb, at 50 μL/min

### Analysis Method 2

### Analysis method: Py-GC/MS (Pyrolysis Gas Chromatograph Mass Spectrometry)

Analysis target substances: cationic components of onium salts, and decomposition products and reactants derived therefrom

Measurement sample: sample obtained by collecting photosensitive layer 11 from hologram recording medium 10, or by collecting hologram layer 11A from hologram optical element 20 Note that details of the method of collecting these layers will be described later.

The analysis conditions are as follows.

Device: GC/MS HP6890 +HP5973 (manufactured by Hewlett-Packard)

Double-Shot Pyrolyzer Py-2020D (manufactured by Frontier Laboratories Ltd.)

Heating temperature: 400° C.

Column: DB-5MS UI (0.25 mm×0.25 μm×30 m)

Injection method: split (split ratio 50:1)

Inlet temperature: 320° C.

Oven temperature: 50° C. (2 min)-20° C./min-320° C. (20 min)

Carrier gas: He (constant flow rate mode, 1.0 ml/min)

Mass range: m/z 29-700

### Method of Analyzing Organic Boron Salt-Based Initiator, Substance Derived Therefrom, and the Like

Examples of the method of analyzing an organic boron salt-based initiator (electron-donating initiator), a substance derived from the organic boron salt-based initiator, and the like contained in the hologram recording medium 10 or the hologram optical element 20 also include, but are not limited to, the above-described analysis method 1 and analysis method 2.

### Method of Analyzing Compound Represented by General Formula (1), Polymer Thereof, and the Like

Examples of the method of analyzing a compound represented by the general formula (1), a polymer of the compound, and the like contained in the hologram recording medium 10 or the hologram optical element 20 include, but are not limited to, the following analysis method.

### Analysis Method

### Analysis method: Py-GC/MS (Pyrolysis Gas Chromatograph Mass Spectrometry)

Analysis target substance: compound represented by general formula (1), or compound having same mother skeleton as that in general formula (1)

Measurement sample: sample obtained by collecting photosensitive layer 11 from hologram recording medium 10, or by collecting hologram layer 11A from hologram optical element 20

Note that details of the method of collecting these layers will be described later.

Device: GC/MS HP6890 +HP5973 (manufactured by Hewlett-Packard)

Double-Shot Pyrolyzer Py-2020D (manufactured by Frontier Laboratories Ltd.)

Details of the analysis conditions are as follows.

Heating temperature: 400° C.

Column: DB-5MS UI (0.25 mm×0.25 μm×30 m)

Injection method: split (split ratio 50:1)

Inlet temperature: 320° C.

Oven temperature: 50° C. (2 min)-20° C./min-320° C. (20 min)

Carrier gas: He (constant flow rate mode, 1.0 ml/min)

Mass range: m/z 29-700

### Method of Collecting Photosensitive Layer 11 from Hologram Recording Medium 10

Examples of the method of collecting the photosensitive layer 11 from the hologram recording medium 10 include, but are not limited to, the following method. First, in a case where a release layer 13 is attached, the release layer 13 is peeled off from the photosensitive layer 11. Subsequently, the photosensitive layer 11 is rubbed off from a protective layer 12, and thus the photosensitive layer 11 is collected. Alternatively, the photosensitive layer 11 with the protective layer 12 still attached is immersed in an organic solvent that does not affect the protective layer 12 to extract the components of the photosensitive layer 11 into the organic solvent. Even in a case where the release layer 13 cannot be peeled off from the photosensitive layer 11, extraction with an organic solvent can be used. As the organic solvent that does not affect the protective layer 12 and the release layer 13, for example, an organic solvent is used such as acetone, methyl ethyl ketone, methanol, ethanol, tetrahydrofuran, toluene, methylene chloride, chloroform, or the like.

### Method of Collecting Hologram Layer 11A from Hologram Optical Element 20

Examples of the method of collecting the hologram layer 11A from the hologram optical element 20 include, but are not limited to, the following method. First, a support 21 is peeled off from the hologram layer 11A. Subsequently, the hologram layer 11A is rubbed off from the protective layer 12, and thus the hologram layer 11A is collected. Alternatively, the hologram layer 11A with the protective layer 12 still attached is immersed in an organic solvent that does not affect the protective layer 12 to extract the components of the hologram layer 11A into the organic solvent. Even in a case where the support 21 cannot be peeled off from the hologram layer 11A, extraction with an organic solvent can be used. As the organic solvent that does not affect the protective layer 12 and the support 21, for example, an organic solvent is used such as acetone, methyl ethyl ketone, methanol, ethanol, tetrahydrofuran, toluene, methylene chloride, chloroform, or the like.

### EXAMPLES

Hereinafter, the present disclosure will be specifically described with reference to examples, but the present disclosure is not limited to only these examples.

In the following Examples and Comparative Examples, the maximum load on a film as a protective layer was determined with the measurement method described in the first embodiment.

### Synthesis of Polymerizable Compound

The polymerizable compound (compound represented by the chemical formula (6-3)) used in the following Examples and Comparative Examples was synthesized as follows.

### Test Example 1

### Synthesis Method of Compound Represented by Chemical Formula (6-3)

The synthesis method (synthesis route) of the compound represented by the chemical formula (6-3) is as follows.

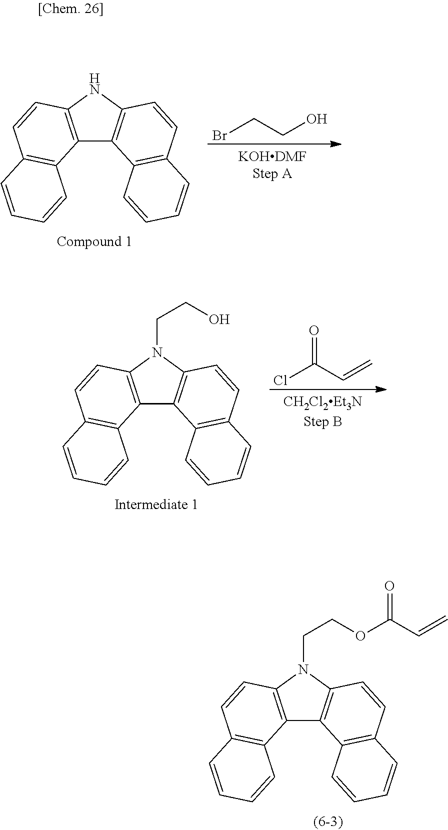

### Step A

The step A in the synthesis route shown above will be described.

Under an inert atmosphere, 110 mL of an N,N-dimethylformamide (manufactured by KANTO CHEMICAL CO., INC.) solution was prepared by mixing with 20 g of potassium hydroxide (manufactured by KANTO CHEMICAL CO., INC.), 15 g of a compound 1 (7H-dibenzo[c,g]carbazole (manufactured by Tokyo Chemical Industry Co., Ltd.)) was added, the resulting mixture was stirred for 1 hour, and then 25 g of 2-bromoethanol (manufactured by Tokyo Chemical Industry Co., Ltd.) was added and reacted for 20 hours. The resulting product was quenched by adding water, and subjected to extraction with toluene using a separatory funnel and to column purification, and thus 10 g of a target product (intermediate 1) was obtained.

### Step B

The step B in the synthesis route shown above will be described.

In a solution obtained by mixing triethylamine (manufactured by KANTO CHEMICAL CO., INC.) with 50 mL of methylene chloride (manufactured by KANTO CHEMICAL CO., INC.), 9 g of the intermediate 1 was dissolved, and the solution was cooled in an ice bath. Thereafter, 3 mL of acryloyl chloride (manufactured by Tokyo Chemical Industry Co., Ltd.) was added little by little, and the mixture was naturally heated to room temperature and reacted for 4 hours. The resulting product was quenched by adding water and subjected to extraction with methylene chloride (manufactured by KANTO CHEMICAL CO., INC.) using a separatory funnel, then the organic layer was washed with saline and subjected to silica filtration and then to column purification to obtain 6 g of a compound of Test Example 1 (compound represented by the chemical formula (6-3)).

The structure of the compound of Test Example 1 (compound represented by the chemical formula (6-3)) was identified using NMR. The result of NMR is as follows.

1H NMR (CDCl₃): 4.60-4.64 (2H), 4.85-4.89 (2H), 5.74-5.76 (1H), 5.95-6.05 (1H), 6.25-6.31 (1H), 7.49-7.55 (2H), 7.65-7.69 (2H), 7.70-7.77 (2H), 7.91-7.94 (2H), 8.03-8.06 (2H), 9.18-9.22 (2H)

### Examples 1 to 6 and Comparative Examples 1 to 4

### Step of Preparing Photosensitive Composition

First, the radical polymerizable monomers, the binder resin, the plasticizer, the sensitizing dyes, the initiators, the chain transfer agent, the polymerization inhibitor, and the UV sensitizer described in Tables 1 and 2 were prepared, and these materials were weighed out at a proportion described in Tables 1 and 2. Subsequently, the weighed materials were mixed in a solvent at normal temperature to prepare a photosensitive composition. As the solvent, a mixture obtained by mixing methyl ethyl ketone (manufactured by KANTO CHEMICAL CO., INC.) and ethanol (manufactured by KANTO CHEMICAL CO., INC.) in advance at a weight ratio of 80 and 20, respectively, was used.

### Step of Producing Hologram Recording Medium

The photosensitive composition was applied, with a bar coater so as to have a dry film thickness of 3 to 5 μm, onto a protective layer, and dried by heating at 60° C. for 1 minute. Next, the thin film surface of the photosensitive layer including the photosensitive composition was pressure-bonded onto a glass substrate having a thickness of 1.0 mm to produce a hologram recording medium having a rectangular shape with a width of 25 mm and a length of 57 mm. As the protective layer, films including materials described in Tables 1 and 2 were used.

### Hologram Recording and Fixing Treatment

In the hologram recording medium, a partial area of the hologram recording medium immediately after the production was subjected to two-beam interference exposure using a diode-pumped solid-state laser having an exposure wavelength described in Tables 1 and 2. Thereafter, the entire surface was irradiated with UV light to cure the uncured monomer, and the refractive index distribution was fixed in the medium and decoloring treatment was performed. For the exposure, an optical system (optical system for hologram recording) illustrated in FIG. 4 was used. A hologram optical element was produced with the above-described process.

Furthermore, as the diode-pumped solid-state laser and the UV light irradiation device, the following devices were used.

### Diode-Pumped Solid-State Laser

660 nm Diode-pumped solid-state laser: manufactured by Cobolt AB, product name: Flamenco 660 nm 500 mW

532 nm Diode-pumped solid-state laser: manufactured by Cobolt AB, product name: Samba 532 nm 1000 mW

457 nm Diode-pumped solid-state laser: manufactured by Melles Griot, product name: 85 BLS 601 457 nm 300 mW

### UV Light Irradiation Device

CV-1LC-G: manufactured by Heraeus, product name: CV-1LC-G, LED lamp used: Semray UV4003, integrated UV light amount: 4 J·cm⁻², wavelength: 365 nm)

### Examples 9 and 10 and Comparative Examples 5 and 6

In the step of preparing a photosensitive composition, the radical polymerizable monomers, the binder resin, the plasticizers, the sensitizing dyes, the initiators, the chain transfer agent, the polymerization inhibitor, and the UV sensitizer described in Table 3 were prepared, and these materials were weighed out at a proportion described in Table 3, and thus a photosensitive composition was prepared. A hologram recording medium and a hologram optical element were produced in a manner similar to that in Example 1 except for this procedure.

### Evaluation

The hologram optical element produced as described above was evaluated as follows.

### Evaluation of Diffraction Efficiency

In the hologram optical element, the transmitted light intensity of an area not subjected to two-beam interference exposure was measured using a spectroscope and a light source that emits light having a wavelength of at least 400 to 700 nm, and the obtained value was defined as reference light intensity. The transmitted light intensity of the area in which the hologram optical element was subjected to two-beam interference exposure was measured using a similar device, and the obtained value was taken as the sample light intensity. In the case of measuring the sample light intensity and the reference light intensity, the incident angle from the light source to the hologram optical element was in accordance with the incident angle of the first light flux or the second light flux at the time of hologram recording, and the light incident on the hologram optical element for determining the sample light intensity was defined as reproduction illumination light. The diffraction efficiency (%) was determined from the following formula.

Diffraction efficiency (%); 100−(sample light intensity at each wavelength)/(transmitted light intensity at each wavelength)×100

As the spectroscope and the light source, the following devices were used.

### Spectroscope

USB4000 manufactured by Ocean Optics, Inc.

### Light Source

L9588 (visible light) manufactured by HAMAMATSU PHOTONICS K.K.

### Evaluation of Refractive Index Modulation Amount (Δn)

On the basis of the theoretical formula by Kogelnik described in Bell Syst. Tech. J., 48, 2909 (1969), An was determined from the maximum diffraction efficiency, the wavelength of the reproduction illumination light, the incident angle of the reproduction illumination light, the grating period of the diffraction grating, the grating inclination angle of the diffraction grating, the film thickness of the hologram layer of the hologram optical element, and the average refractive index of the hologram layer of the hologram optical element, which were known, using the relational expression for the time of satisfying the Bragg condition in a reflection-type volume phase hologram among the Δn, the maximum diffraction efficiency, the wavelength of reproduction illumination light, the incident angle of the reproduction illumination light, the film thickness of the hologram layer of the hologram optical element, and the average refractive index of the hologram layer of the hologram optical element. Note that the maximum diffraction efficiency used was the highest diffraction efficiency of the diffraction efficiencies at wavelengths obtained by the method described in (Evaluation of Diffraction Efficiency) above. In addition, the grating period and the grating inclination angle of the diffraction grating were determined on the basis of the description in Bell Syst. Tech. J., 48, 2909 (1969) from the incident angles of the first light flux and the second light flux at the time of hologram recording, the wavelengths of the first light flux and the second light flux, and the average refractive index of the photosensitive layer of the hologram recording medium. The An obtained by the above method is shown in Tables 1, 2, and 3.

### Evaluation of Maximum Difference in Peak Wavelength

The diffraction peak wavelength of the hologram optical element formed in the hologram recording area (area: 180 mm²) was measured, and the difference between the maximum diffraction wavelength and the minimum diffraction wavelength obtained was regarded as the maximum difference in peak wavelength. Tables 1, 2, and 3 show the results. Note that in a condition of exposure to a plurality of colors, the maximum difference in peak wavelength was evaluated for the diffraction peak wavelengths of each color, and among the evaluated maximum differences, the largest difference value in peak wavelength was shown.

### Evaluation of Peelability

To the hologram optical element (width: 25 mm, length: 57 mm) pressure-bonded to the glass substrate, an adhesive tape was attached at one end portion in the short direction (length direction) from the protective layer side and peeled off by hand, and whether or not the hologram optical element (laminate including the protective layer and the hologram layer) was peelable from the glass substrate was evaluated. As the tape, a square tape having a length of 18 mm and a width of 18 mm was used. In a case where only the protective layer was peeled off or the hologram layer or the protective layer was broken, the hologram optical element was evaluated to be non-peelable. Tables 1, 2, and 3 show the results.

TABLE 1

| | | | | | Comparative | Comparative | Comparative |
|---|---|---|---|---|---|---|---|
| | | | Example 1 | Example 2 | Example 1 | Example 2 | Example 3 |
| Photosensitive | Monomer | EA-0200 | 36.80 | 36.80 | 36.80 | 36.80 | 36.80 |
| composition | | EACz | 8.20 | 8.20 | 8.20 | 8.20 | 8.20 |
| | Binder resin | SN-55T | 19.38 | 19.38 | 19.38 | 19.38 | 19.38 |
| | Plasticizer | EX212L | 30.00 | 30.00 | 30.00 | 30.00 | 30.00 |
| | Sensitizing dye | RB | 2.25 | 2.25 | 2.25 | 2.25 | 2.25 |
| | Initiator | I0591 | 8.43 | 8.43 | 8.43 | 8.43 | 0 |
| | | (onium salt- | | | | | |
| | | based initiator) | | | | | |
| | | P3B | 3.42 | 3.42 | 3.42 | 0 | 3.42 |
| | | (organic | | | | | |
| | | boron salt- | | | | | |
| | | based initiator) | | | | | |
| | Chain transfer | 2-MBO | 0.56 | 0.56 | 0.56 | 0.56 | 0.56 |
| | agent | | | | | | |
| | Polymerization | PT | 0.15 | 0.15 | 0.15 | 0.15 | 0.15 |
| | inhibitor | | | | | | |
| | UV sensitizer | UVS-1331 | 2.67 | 2.67 | 2.67 | 2.67 | 2.67 |

| | | | | | | |
|---|---|---|---|---|---|---|
| | Solute concentration | 30.0 | 30.0 | 30.0 | 30.0 | 30.0 |
| | Dry film thickness | 3 | 3 | 3 | 3 | 3 |
| Protective | Material | PC | COP-23 | PVA | PC | PC |
| layer | Maximum load [N] | 100 | 10 | 2.8 | 100 | 100 |
| Exposure | Exposure wavelength [nm] | 532 | 532 | 532 | 532 | 532 |
| condition | Incident angle θ₁ of first light | 35.0 | 35.0 | 35.0 | 35.0 | 35.0 |
| | flux [deg] | | | | | |
| | Incident angle θ₂ of second light | 40.0 | 40.0 | 40.0 | 40.0 | 40.0 |
| | flux [deg] | | | | | |
| Evaluation | Δn | 0.032 | 0.028 | 0.029 | 0.05 | diffracted light |
| result | | | | | | was not detected |
| | Maximum difference in peak | 18 | 8 | 13 | 115 | diffracted light |
| | wavelength [nm] | | | | | was not detected |
| | Peelability | Peelable | Peelable | Non-peelable | Non-peelable | Peelable |

TABLE 2

| | | | Example 3 | Example 4 | Example 5 | Example 6 |
|---|---|---|---|---|---|---|
| Photosensitive | Monomer | EA-0200 | 36.80 | 36.80 | 20.00 | 20.00 |
| composition | | EACz | 8.20 | 8.20 | 0 | 0 |
| | | 6-3 | 0 | 0 | 25.00 | 25.00 |
| | Binder resin | SN-55T | 19.38 | 19.38 | 19.38 | 19.38 |
| | Plasticizer | EX212L | 30.00 | 30.00 | 30.00 | 30.00 |
| | Sensitizing dye | AOG | 0.78 | 0.78 | 0.78 | 0.78 |
| | | SFO | 0.08 | 0.08 | 0.08 | 0.08 |
| | | MB | 0.47 | 0.47 | 0.47 | 0.47 |
| | Initiator | I0591 | 8.43 | 8.43 | 8.43 | 8.43 |
| | | (onium salt- | | | | |
| | | based initiator) | | | | |
| | | P3B | 3.42 | 3.42 | 3.42 | 3.42 |
| | | (organic | | | | |
| | | boron salt- | | | | |
| | | based initiator) | | | | |
| | Chain transfer | 2-MBO | 0.56 | 0.56 | 0.56 | 0.56 |
| | agent | | | | | |
| | Polymerization | PT | 0.08 | 0.08 | 0.08 | 0.15 |
| | inhibitor | | | | | |
| | UV sensitizer | UVS-1331 | 1.39 | 1.39 | 1.39 | 1.39 |

| | | | | | |
|---|---|---|---|---|---|
| | Solute concentration [%] | 27.60 | 27.60 | 27.60 | 27.60 |
| | Dry film thickness [nm] | 5 | 5 | 5 | 5 |
| Protective | Material | PC | COP-23 | PC | COP-23 |
| layer | Maximum load [N] | 100 | 10 | 100 | 10 |
| Exposure | Exposure wavelength [nm] | 457, 532, 660 | 457, 532, 660 | 457, 532, 660 | 457, 532, 660 |
| condition | Incident angle θ₁ of first light | 6.5 | 6.5 | 6.5 | 6.5 |
| | flux [deg] | | | | |
| | Incident angle θ₂ of second light | 9.5 | 9.5 | 9.5 | 9.5 |
| | flux [deg] | | | | |
| Evaluation | ΣΔn | 0.036 | 0.033 | 0.068 | 0.063 |
| result | Maximum difference in peak | 4 | 7 | 7 | 6 |
| | wavelength [nm] | | | | |
| | Peelability | Peelable | Peelable | Peelable | Peelable |

| | | | | | Comparative |
|---|---|---|---|---|---|
| | | | Example 7 | Example 8 | Example 4 |
| Photosensitive | Monomer | EA-0200 | 20.00 | 20.00 | 20.00 |
| composition | | EACz | 0 | 0 | 0 |
| | | 6-3 | 25.00 | 25.00 | 25.00 |
| | Binder resin | SN-55T | 19.38 | 19.38 | 19.38 |
| | Plasticizer | EX212L | 30.00 | 30.00 | 30.00 |
| | Sensitizing dye | AOG | 0.78 | 0.78 | 0.78 |
| | | SFO | 0.08 | 0.08 | 0.08 |
| | | MB | 0.47 | 0.47 | 0.47 |
| | Initiator | I0591 | 8.43 | 8.43 | 8.43 |
| | | (onium salt- | | | |
| | | based initiator) | | | |
| | | P3B | 3.42 | 3.42 | 3.42 |
| | | (organic | | | |
| | | boron salt- | | | |
| | | based initiator) | | | |
| | Chain transfer | 2-MBO | 0.56 | 0.56 | 0.56 |
| | agent | | | | |
| | Polymerization | PT | 0.15 | 0.15 | 0.15 |
| | inhibitor | | | | |
| | UV sensitizer | UVS-1331 | 1.39 | 1.39 | 1.39 |

| | | | | |
|---|---|---|---|---|
| | Solute concentration [%] | 27.60 | 27.60 | 27.60 |
| | Dry film thickness [nm] | 5 | 5 | 5 |
| Protective | Material | COP-13 | PET | PVA |
| layer | Maximum load [N] | 4.8 | 80 | 2.8 |
| Exposure | Exposure wavelength [nm] | 457, 532, 660 | 457, 532, 660 | 457, 532, 660 |
| condition | Incident angle θ₁ of first light | 6.5 | 6.5 | 6.5 |
| | flux [deg] | | | |
| | Incident angle θ₂ of second light | 9.5 | 9.5 | 9.5 |
| | flux [deg] | | | |
| Evaluation | ΣΔn | 0.049 | 0.05 | 0.055 |
| result | Maximum difference in peak | 8 | 13 | 11 |
| | wavelength [nm] | | | |
| | Peelability | Peelable | Peelable | Non-peelable |

TABLE 3

| | | | | | Comparative | Comparative |
|---|---|---|---|---|---|---|
| | | | Example 9 | Example 10 | Example 5 | Example 6 |
| Photosensitive | Monomer | EA-0200 | 36.80 | 36.80 | 36.80 | 36.80 |
| composition | | EACz | 8.20 | 8.20 | 8.20 | 8.20 |
| | Binder resin | SN-55T | 19.38 | 19.38 | 19.38 | 19.38 |
| | Plasticizer | EX212L | 30.00 | 30.00 | 30.00 | 30.00 |
| | Sensitizing dye | AOG | 0.78 | 0 | 0.78 | 0 |
| | | SFO | 0.08 | 0 | 0.08 | 0 |
| | | BCP | 0 | 0.18 | 0 | 0.18 |
| | | MB | 0.47 | 0.47 | 0.47 | 0.47 |
| | Initiator | IRAGACURE 290 | 11.55 | 11.55 | 11.55 | 11.55 |
| | | (onium salt- | | | | |
| | | based initiator) | | | | |
| | | P3B | 3.42 | 3.42 | 3.42 | 3.42 |
| | | (organic | | | | |
| | | boron salt- | | | | |
| | | based initiator) | | | | |
| | Chain transfer | 2-MBO | 0.56 | 0.56 | 0.56 | 0.56 |
| | agent | | | | | |
| | Polymerization | PT | 0.08 | 0.08 | 0.08 | 0.08 |
| | inhibitor | | | | | |
| | UV sensitizer | UVS-1331 | 1.39 | 1.39 | 1.39 | 1.39 |

| | | | | | |
|---|---|---|---|---|---|
| | Solute concentration [%] | 27.6 | 27.6 | 27.6 | 27.6 |
| | Dry film thickness [nm] | 5 | 5 | 5 | 5 |
| Protective | Material | COP-23 | COP-23 | PVA | PVA |
| layer | Maximum load [N] | 10 | 10 | 2.8 | 2.8 |
| Exposure | Exposure wavelength [nm] | 457, 532, 660 | 457, 532, 660 | 457, 532, 660 | 457, 532, 660 |
| condition | Incident angle θ₁ of first light | 6.5 | 6.5 | 6.5 | 6.5 |
| | flux [deg] | | | | |
| | Incident angle θ₂ of second light | 9.5 | 9.5 | 9.5 | 9.5 |
| | flux [deg] | | | | |
| Evaluation | ΣΔn | 0.034 | 0.048 | 0.044 | 0.044 |
| result | Maximum difference in peak | 14 | 11 | 12 | 3 |
| | wavelength [nm] | | | | |
| | Peelability | Peelable | Peelable | Non-peelable | Non-peelable |

In Tables 1, 2, and 3, the unit of the numerical value of the amount of each component in the photosensitive composition is “part by mass”. The solute concentration indicates the total content of components contained in a coating liquid in Tables by “mass %”.

Furthermore, the incident angle θ₁ of the first light flux and the incident angle θ₂ of the second light flux are defined as described in the second embodiment (see FIG. 5).

Details of each material described in Tables 1, 2, and 3 are as follows.

### Monomer

EA-0200: fluorene-based acrylate monomer (manufactured by Osaka Gas Chemicals Co., Ltd., product name: EA-0200) (polymerizable compound represented by chemical formula (10-1) in first embodiment)

EACz: 2-(9H-carbazol-9-yl)ethyl acrylate (manufactured by SIGMA-ALDRICH Co. LLC) (polymerizable compound represented by chemical formula (0-4) in first embodiment)

6-3: Polymerizable compound represented by chemical formula (6-3) in first embodiment

### Binder Resin

SN-55T: polyvinyl acetate (manufactured by DENKI KAGAKU KOGYO KABUSHIKI KAISHA, product name: DENKA SAKNOHOL SN-55T)

### Plasticizer

EX 212L: 1,6-hexanediol diglycidyl ether (manufactured by Nagase ChemteX Corporation, product name: EX 212L)

### Sensitizing Dye

RB: rose bengal (manufactured by SIGMA-ALDRICH Co. LLC)

MB: methylene blue (manufactured by Tokyo Chemical Industry Co., Ltd.)

SFO: Safranin O (manufactured by SIGMA-ALDRICH Co. LLC)

AOG: Astrazon Orange G (manufactured by SIGMA-ALDRICH Co. LLC)

BCP: (2E,5E)-2,5-bis[(4(diethylamino)phenyl)methylene]cyclopentanone (manufactured by ACROS ORGANICS)

### Initiator

I0591 (onium salt-based initiator): 4-isopropyl-4′-methyldiphenyliodonium tetrakis(pentafluorophenyl)borate (manufactured by Tokyo Chemical Industry Co., Ltd., product name: I0591)

IRGACURE 290 (onium salt-based initiator): triarylsulfonium borate salt (manufactured by BASF, product name: IRGACURE 290)

P3B (organic boron salt-based initiator): tetrabutylammonium=butyltriphenylborate (manufactured by Showa Denko K.K., product name: P3B)

### Chain Transfer Agent

2-MBO: 2-mercaptobenzoxazole (manufactured by Tokyo Chemical Industry Co., Ltd.)

### Polymerization Inhibitor

PT: phenothiazine (manufactured by FUJIFILM Wako Pure Chemical Corporation)

### UV Sensitizer

UVS 1331: 9,10 dibutoxyanthracene (manufactured by Kawasaki Kasei Chemicals Ltd., product name: UVS-1331)

### Protective Layer

PVA: polyvinyl alcohol film (self-made, film thickness: 2.5 μm)

PC: polycarbonate film with hard coat (manufactured by TEIJIN LIMITED, product name: XPC806C, film thickness: 100 μm (excluding hard coat layer))

COP-23: cycloolefin polymer (manufactured by Zeon Corporation, product name: ZF14-023, film thickness: 23 μm)

COP-13: cycloolefin polymer (manufactured by Zeon Corporation, product name: ZF14-013, film thickness: 13 μm)

PET: polyethylene terephthalate (manufactured by LINTEC Corporation, film thickness: 39 μm)

The following is found from Table 1.

If the initial maximum load on the protective layer is 3 N or more and the polymerizable initiator contains an electron-donating initiator (organic boron salt-based initiator) and an electron-accepting initiator (onium salt-based initiator), the maximum difference in peak wavelength is small, and the hologram optical element can be peeled off from the release layer (glass substrate) after exposure (see Examples 1 and 2).

Even if the polymerizable initiator contains an electron-donating initiator (organic boron salt-based initiator) and an electron-accepting initiator (onium salt-based initiator), in the case of an initial maximum load on the protective layer of less than 3 N, the hologram optical element cannot be peeled off from the release layer (glass substrate) (see Comparative Example 1).

Even if the initial maximum load on the protective layer is 3 N or more, in the case of a polymerizable initiator not containing an electron-donating initiator (organic boron salt-based initiator), the maximum difference in peak wavelength is large, and the hologram optical element cannot be peeled off from the release layer (glass substrate) after exposure (see Comparative Example 2).

Even if the initial maximum load on the protective layer is 3 N or more, in the case of a polymerizable initiator not containing an electron-accepting initiator (onium salt-based initiator), diffracted light cannot be obtained (see Comparative Example 3).

Note that the in-plane uniformity of a diffraction peak wavelength can be evaluated from the maximum difference in peak wavelength, and the in-plane uniformity of a diffraction peak wavelength is high when the maximum difference in peak wavelength is small.

The following is found from Table 2.

If the photosensitive layer contains a polymerizable compound represented by the general formula (1) (radical polymerizable monomer), a high refractive index modulation degree (Δn) is obtained without a heating step after exposure (see Examples 3 to 8).

Even in a case where the photosensitive layer contains a polymerizable compound represented by the general formula (1) (radical polymerizable monomer), if the initial maximum load on the protective layer is less than 3 N, the hologram optical element cannot be peeled off from the release layer (glass substrate) (see Comparative Example 4).

Also in the case of a photosensitive layer containing three kinds of sensitizing dyes (AOG, SFO, MB), an effect similar to that in the case of a photosensitive layer containing one kind of sensitizing dye (RB) is obtained (see Examples 1 to 4).

The following is found from Table 3.

Also in the case of using IRGACURE 290 as the electron-accepting initiator (onium salt-based initiator), an effect similar to that in the case of using I0591 as the electron-accepting initiator (onium salt-based initiator) can be obtained (see Examples 1, 2, 9, and 10 and Comparative Examples 1, 5, and 6).

Also in the case of a photosensitive layer containing two kinds of sensitizing dyes (BCP, MB) or three kinds of sensitizing dyes (AOG, SFO, MB), an effect similar to that in the case of a photosensitive layer containing one kind of sensitizing dye (RB) is obtained (see Examples 1, 2, 9, and 10).

Although the embodiments of the present disclosure are heretofore described specifically, the present disclosure is not limited to the above-described embodiments, and various modifications based on the technical idea of the present disclosure can be made.

For example, the configurations, the methods, the steps, the shapes, the materials, the numerical values, and the like described in the above-described embodiments are merely examples, and a configuration, a method, a step, a shape, a material, a numerical value, and the like that are different from those in the above-described embodiments may also be used as necessary.

Furthermore, the configurations, the methods, the steps, the shapes, the materials, the numerical values, and the like of the above-described embodiments can be combined with each other without departing from the gist of the present disclosure.

Furthermore, in the numerical value ranges described in stages in the above-described embodiments, an upper limit or a lower limit of a numerical value range of a certain stage may be replaced with an upper limit or a lower limit of a numerical value range of another stage. The materials exemplified in the above-described embodiments can be used alone or in combination of two or more kinds thereof unless otherwise specified.

Furthermore, the present disclosure can also employ the following configurations.

### (1)

A hologram recording medium including:

a protective layer; and a photosensitive layer, the photosensitive layer containing a polymerizable compound and a polymerization initiator,
the polymerization initiator containing an electron-donating initiator and an electron-accepting initiator, in which
an initial maximum load on the protective layer measured in a tensile test is 3 N or more and 1000 N or less.

### (2)

The hologram recording medium according to (1), in which the photosensitive layer further contains a binder resin and a sensitizing dye.

### (3)

The hologram recording medium according to (1) or (2), in which

the electron-donating initiator includes an organic boron salt-based initiator, and

the electron-accepting initiator includes an onium salt-based initiator.

### (4)

The hologram recording medium according to any one of (1) to (3), in which the protective layer contains at least one selected from the group consisting of cycloolefin-based resins, polycarbonate-based resins, and polyester-based resins.

### (5)

The hologram recording medium according to any one of (1) to (4), in which the polymerizable compound is represented by a general formula (1) described below.

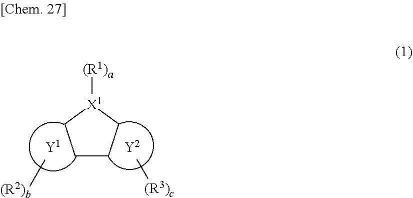

In the general formula (1), X¹ represents an oxygen atom, a nitrogen atom, a phosphorus atom, a carbon atom, or a silicon atom. In a case where X¹ represents an oxygen atom, a is 0, in a case where X¹ represents a nitrogen atom or a phosphorus atom, a is 1, and in a case where X¹ represents a carbon atom or a silicon atom, a is 2.

Y¹ and Y² each represent a benzene ring or a naphthalene ring. In a case where Y¹ and/or Y² represents a benzene ring, b or c corresponding to Y¹ and/or Y² representing the benzene ring is 4. In a case where Y¹ and/or Y² represents a naphthalene ring, b and/or c corresponding to Y¹ and/or Y² representing the naphthalene ring is 6.

R¹ to R³ each represent hydrogen or a substituent represented by *-Z¹ (R⁴)_{d} (in which * represents a binding site). In a case where a plurality of R¹s, a plurality of R²s, and a plurality of R³s are present, the plurality of R¹s, the plurality of R²s, and the plurality of R³s may be of an identical kind or of different kinds, and all of the plurality of R¹s, the plurality of R²s, and the plurality of R³s in the general formula (1) are not simultaneously hydrogen.

Z¹ represents a single bond, a divalent or higher saturated hydrocarbon group, or a divalent or higher unsaturated hydrocarbon group, and the divalent or higher saturated hydrocarbon group or the divalent or higher unsaturated hydrocarbon group may contain an ether bond and/or a thioether bond. In a case where Z¹ represents a single bond, d is 1, and in a case where Z¹ represents a divalent or higher saturated hydrocarbon group or a divalent or higher unsaturated hydrocarbon group, d is an integer of 1 or more.

R⁴ represents hydrogen or a polymerizable substituent. In a case where a plurality of R⁴s is present, the plurality of R⁴s may be of an identical kind or of different kinds, and all of the plurality of R⁴s in the general formula (1) is not simultaneously hydrogen.

### (6)

The hologram recording medium according to (5), in which the polymerizable compound contains a compound represented by the general formula (1) in which X¹ represents a nitrogen atom.

### (7)

The hologram recording medium according to (5) or (6), in which Y¹ and Y² in the general formula (1) are not simultaneously a benzene ring.

### (8)

The hologram recording medium according to (5) or (6), in which both Y¹ and Y² in the general formula (1) are a naphthalene ring.

### (9)

A hologram recording medium according to any one of (1) to (8), further including

a release layer, in which

the protective layer is provided on a first surface of the photosensitive layer, and

the release layer is provided on a second surface of the photosensitive layer.

### (10)

A hologram optical element including:

a protective layer; and a hologram layer,

the hologram layer containing a polymer and a polymerization initiator having a structure changed by irradiation with external energy, the irradiation that generates an active species,

the polymerization initiator containing an electron-donating initiator and an electron-accepting initiator, in which

an initial maximum load on the protective layer measured in a tensile test is 3 N or more and 1000 N or less.

### (11)

The hologram optical element according to (10), in which the polymer contains at least one of an acrylate polymer or a methacrylate polymer.

### (12)

An optical device including the hologram optical element according to (10) or (11).

### (13)

An optical component including the hologram optical element according to (10) or (11).

### (14)

A method for forming a hologram diffraction grating, the method including

selectively reacting a hologram recording medium including a protective layer and a photosensitive layer, by using an electromagnetic ray having an amplitude modulated spatially,

the photosensitive layer containing a polymerizable compound and a polymerization initiator,

the polymerization initiator containing an electron-donating initiator and an electron-accepting initiator, in which

an initial maximum load on the protective layer measured in a tensile test is 3 N or more and 1000 N or less.

### REFERENCE SIGNS LIST

10 Hologram recording medium

11 Photosensitive layer

12 Protective layer

11 A Hologram layer

13 Release layer

20 Hologram optical element

21 Support

1. A hologram recording medium comprising:
a protective layer; and a photosensitive layer,
the photosensitive layer containing a polymerizable compound and a polymerization initiator,
the polymerization initiator containing an electron-donating initiator and an electron-accepting initiator, wherein
an initial maximum load on the protective layer measured in a tensile test is 3 N or more and 1000 N or less.

2. The hologram recording medium according to claim 1, wherein the photosensitive layer further contains a binder resin and a sensitizing dye.

3. The hologram recording medium according to claim 1, wherein
the electron-donating initiator includes an organic boron salt-based initiator, and
the electron-accepting initiator includes an onium salt-based initiator.

4. The hologram recording medium according to claim 1, wherein the protective layer contains at least one selected from the group consisting of cycloolefin-based resins, polycarbonate-based resins, and polyester-based resins.

5. The hologram recording medium according to claim 1, wherein the polymerizable compound is represented by a general formula (1) described below: 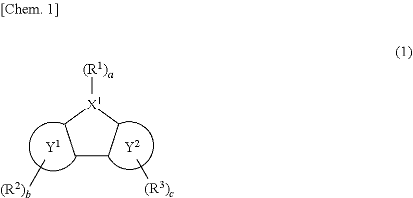
wherein X¹ represents an oxygen atom, a nitrogen atom, a phosphorus atom, a carbon atom, or a silicon atom, and in a case where X¹ represents an oxygen atom, a is 0, in a case where X¹ represents a nitrogen atom or a phosphorus atom, a is 1, and in a case where X¹ represents a carbon atom or a silicon atom, a is 2,
Y¹ and Y² each represent a benzene ring or a naphthalene ring, and in a case where Y¹ and/or Y² represents a benzene ring, b or c corresponding to Y¹ and/or Y² representing the benzene ring is 4, and in a case where Y¹ and/or Y² represents a naphthalene ring, b and/or c corresponding to Y¹ and/or Y² representing the naphthalene ring is 6,
R¹ to R³ each represent hydrogen or a substituent represented by *-Z¹ (R⁴)_{d} (in which * represents a binding site), and in a case where a plurality of R¹s, a plurality of R²s, and a plurality of R³s are present, the plurality of R¹s, the plurality of R²s, and the plurality of R³s may be of an identical kind or of different kinds, and all of the plurality of R¹s, the plurality of R²s, and the plurality of R³s in the general formula (1) are not simultaneously hydrogen,
Z¹ represents a single bond, a divalent or higher saturated hydrocarbon group, or a divalent or higher unsaturated hydrocarbon group, and the divalent or higher saturated hydrocarbon group or the divalent or higher unsaturated hydrocarbon group may contain an ether bond and/or a thioether bond, and in a case where Z¹ represents a single bond, d is 1, and in a case where Z¹ represents a divalent or higher saturated hydrocarbon group or a divalent or higher unsaturated hydrocarbon group, d is an integer of 1 or more,
R⁴ represents hydrogen or a polymerizable substituent, and in a case where a plurality of R⁴s is present, the plurality of R⁴s may be of an identical kind or of different kinds, and all of the plurality of R⁴s in the general formula (1) is not simultaneously hydrogen.

6. The hologram recording medium according to claim 5, wherein the polymerizable compound contains a compound represented by the general formula (1) in which X¹ represents a nitrogen atom.

7. The hologram recording medium according to claim 5, wherein Y¹ and Y² in the general formula (1) are not simultaneously a benzene ring.

8. The hologram recording medium according to claim 5, wherein both Y¹ and Y² in the general formula (1) are a naphthalene ring.

9. A hologram recording medium according to claim 1, further comprising
a release layer, wherein
the protective layer is provided on a first surface of the photosensitive layer, and
the release layer is provided on a second surface of the photosensitive layer.

10. A hologram optical element comprising:
a protective layer; and a hologram layer,
the hologram layer containing a polymer and a polymerization initiator having a structure changed by irradiation with external energy, the irradiation that generates an active species,
the polymerization initiator containing an electron-donating initiator and an electron-accepting initiator, wherein
an initial maximum load on the protective layer measured in a tensile test is 3 N or more and 1000 N or less.

11. The hologram optical element according to claim 10, wherein the polymer contains at least one of an acrylate polymer or a methacrylate polymer.

12. An optical device comprising the hologram optical element according to claim 10.

13. An optical component comprising the hologram optical element according to claim 10.

14. A method for forming a hologram diffraction grating, the method comprising
selectively reacting a hologram recording medium including a protective layer and a photosensitive layer, by using an electromagnetic ray having an amplitude modulated spatially,
the photosensitive layer containing a polymerizable compound and a polymerization initiator,
the polymerization initiator containing an electron-donating initiator and an electron-accepting initiator, wherein
an initial maximum load on the protective layer measured in a tensile test is 3 N or more and 1000 N or less.
